(19) United States
(12) Patent Application Publication
(10) Pub. No.: US 2024/0308034 A1
(43) Pub. Date: Sep. 19, 2024

(54) IMPACT WRENCH AND POWER TOOL

(71) Applicant: Makita Corporation, Anjo-shi (JP)

(72) Inventors: Takeshi Kamiya, Anjo-shi (JP); Yumiko Noda, Anjo-shi (JP); Kazunori Kinoshita, Anjo-shi (JP)

(73) Assignee: Makita Corporation, Anjo-shi (JP)

(21) Appl. No.: 18/406,850

(22) Filed: Jan. 8, 2024

(30) Foreign Application Priority Data
Mar. 14, 2023 (JP) 2023-039762

(51) Int. Cl. B25B 21/02; B25B 23/16; B25F 5/00

(52) U.S. Cl. CPC B25B 21/02; B25B 23/16; B25F 5/001

(57) ABSTRACT

An impact wrench includes an anvil to which a socket is attachable, a hammer located above the anvil to strike the anvil in a rotation direction, a brushless motor located above the hammer and including a rotor and a stator, a controller that controls rotation of the brushless motor, a case accommodating the hammer, a rod located above the case, a head located above the rod, accommodating the controller, and including a battery mount to which a battery pack is attachable, a forward-reverse switch, and a panel elongated in a lateral direction, and a grip extending from the head in the lateral direction and including a trigger switch.

### CROSS-REFERENCE TO RELATED APPLICATIONS

This application claims the benefit of priority to Japanese Patent Application No. 2023-039762, filed on Mar. 14, 2023, the entire contents of which are hereby incorporated by reference.

### BACKGROUND

### 1. Technical Field

The present disclosure relates to an impact wrench and a power tool.

### 2. Description of the Background

In the technical field of impact wrenches, a known impact wrench is driven with power supplied from a battery pack, as described in Japanese Unexamined Patent Application Publication (Translation of PCT Application) No. 2019-509182.

### BRIEF SUMMARY

To increase output power from an impact wrench, multiple battery packs may be attached to the impact wrench. The impact wrench may have lower work efficiency depending on the battery packs attached. Other power tools may also have lower work efficiency due to their battery packs.

One or more aspects of the present disclosure are directed to an impact wrench or a power tool receiving at least two battery packs with reduced likelihood of lowered work efficiency.

A first aspect of the present disclosure provides an impact wrench, including:
an anvil to which a socket is attachable;
a hammer at least partially located above the anvil, the hammer being configured to strike the anvil in a rotation direction;
a brushless motor located above the hammer, the brushless motor including
   a rotor configured to rotate the hammer, and
   a stator facing the rotor;
a controller configured to control rotation of the brushless motor;
a case accommodating the hammer;
a rod located above the case;
a head located above the rod and accommodating the controller, the head including
   a battery mount to which a battery pack is attachable in a slidable manner,
   a forward-reverse switch configured to change a rotation direction of the brushless motor, and
   a panel located in an upper portion of the head and elongated in a lateral direction, the panel including
      a speed change button configured to change a rotational speed of the brushless motor, and
      a speed indicator light-emitting diode including a plurality of light-emitting diodes each to be lit based on the rotational speed of the brushless motor selected with the speed change button; and
a grip extending from the head in the lateral direction, the grip including a trigger switch configured to rotate the brushless motor.

The impact wrench according to the above aspect of the present disclosure receives at least two battery packs with reduced likelihood of lowered work efficiency.

### BRIEF DESCRIPTION OF DRAWINGS

FIG. 1 is a perspective view of an impact wrench according to a first embodiment.

FIG. 2 is a sectional view of the impact wrench according to the first embodiment.

FIG. 3 is a top view of the impact wrench according to the first embodiment.

FIG. 4 is a perspective view of an impact wrench according to a second embodiment.

FIG. 5 is a side view of an impact wrench according to a third embodiment.

FIG. 6 is a side view of an impact wrench according to a fourth embodiment.

FIG. 7 is a side view of an impact wrench according to a fifth embodiment.

FIG. 8 is a diagram of an impact wrench according to a sixth embodiment.

FIG. 9 is a plan view of the impact wrench according to the sixth embodiment.

FIG. 10 is a diagram of an impact wrench according to a seventh embodiment.

### DETAILED DESCRIPTION

A first aspect of the present disclosure provides an impact wrench (1A), comprising:
a brushless motor (10A);
striker (15A) rotatable by the brushless motor (10A);
an anvil (16A) strikable by the striker (15A), the anvil (16A) being rotatable about a rotation axis (AX) extending in a direction parallel to X-axis;
a first battery mount (31A) to which a first battery pack (33A) is attachable;
a second battery mount (32A) to which a second battery pack (34A) is attachable, the second battery mount (32A) being not aligned with the first battery mount (31A) in the direction parallel to X-axis.

A second aspect of the present disclosure provides the impact wrench (1A) according to the first aspect, wherein
the first battery pack (33A) is slid relative to the first battery mount (31A) in the direction parallel to X-axis to be attached to the first battery mount (31A), and
the second battery pack (34A) is slid relative to the second battery mount (32A) in a direction parallel to Y-axis being orthogonal to X-axis to be attached to the second battery mount (32A).

A third aspect of the present disclosure provides the impact wrench (1A) according to the second aspect, further comprising:
a body housing (2A) accommodating the brushless motor (10A),
wherein in the direction parallel to Y-axis, the body housing (2A) has an end in a negative Y-direction located farther in the negative Y-direction than an end of the first battery pack (33A) in the negative Y-direction and an end of the second battery pack (34A) in the negative Y-direction, and the body housing (2A) has an end in a positive Y-direction located farther in the positive Y-direction than an end of the first battery pack (33A) in the positive Y-direction and an end of the second battery pack (34A) in the positive Y-direction.

A fourth aspect of the present disclosure provides the impact wrench (1E) according to the first aspect, wherein
the first battery pack (33A) is slid relative to the first battery mount (31A) in the direction parallel to X-axis to be attached to the first battery mount (31A), and
the second battery pack (34A) is slid relative to the second battery mount (32A) in the direction parallel to X-axis and in a direction opposite to a direction in which the first battery pack (33A) is slid to be attached to the second battery mount (32A).

A fifth aspect of the present disclosure provides the impact wrench (1E) according to the fourth aspect, further comprising:
a body housing (2E) accommodating the brushless motor (10A),
wherein in a direction parallel to Y-axis being orthogonal to X-axis, the body housing (2E) has an end in a negative Y-direction located farther in the negative Y-direction than an end of the first battery pack (33A) in the negative Y-direction and an end of the second battery pack (34A) in the negative Y-direction, and the body housing (2E) has an end in a positive Y-direction located farther in the positive Y-direction than an end of the first battery pack (33A) in the positive Y-direction and an end of the second battery pack (34A) in the positive Y-direction.

A sixth aspect of the present disclosure provides the impact wrench (1B) according to the first aspect, wherein
the first battery pack (33A) is slid relative to the first battery mount (31A) in a direction parallel to Y-axis being orthogonal to X-axis to be attached to the first battery mount (31A), and
the second battery pack (34A) is slid relative to the second battery mount (32A) in the direction parallel to Y-axis to be attached to the second battery mount (32A).

A seventh aspect of the present disclosure provides the impact wrench (1B) according to the sixth aspect, further comprising:
a body housing (2A) accommodating the brushless motor (10A),
wherein in the direction parallel to Y-axis, the body housing (2A) has an end in a negative Y-direction located farther in the negative Y-direction than an end of the first battery pack (33A) in the negative Y-direction and an end of the second battery pack (34A) in the negative Y-direction, and the body housing (2A) has an end in a positive Y-direction located farther in the positive Y-direction than an end of the first battery pack (33A) in the positive Y-direction and an end of the second battery pack (34A) in the positive Y-direction.

An eighth aspect of the present disclosure provides an impact wrench (1B), comprising:
a brushless motor (10A);
striker (15A) rotatable by the brushless motor (10A);
an anvil (16B) strikable by the striker (15A), the anvil (16B) being rotatable about a rotation axis (AX) extending in a direction parallel to X-axis;
a first battery mount (31B) to which a first battery pack (33B) is attachable in a manner slidable in a direction parallel to Y-axis being orthogonal to X-axis; and
a second battery mount (32B) to which a second battery pack (34B) is attachable in a manner slidable in the direction parallel to Y-axis, the second battery mount (32B) being adjacent to the first battery mount (31B).

A ninth aspect of the present disclosure provides the impact wrench (1B) according to the eighth aspect, further comprising:
a body housing (2B) accommodating the brushless motor (10A),
wherein in the direction parallel to Y-axis, the body housing (2B) has an end in a negative Y-direction located farther in the negative Y-direction than an end of the first battery pack (33B) in the negative Y-direction and an end of the second battery pack (34B) in the negative Y-direction, and the body housing (2B) has an end in a positive Y-direction located farther in the positive Y-direction than an end of the first battery pack (33B) in the positive Y-direction and an end of the second battery pack (34B) in the positive Y-direction.

A tenth aspect of the present disclosure provides an impact wrench (1B), comprising:
a brushless motor (10A);
striker (15A) rotatable by the brushless motor (10A);
an anvil (16B) strikable by the striker (15A), the anvil (16B) being rotatable about a rotation axis (AX) extending in a direction parallel to X-axis;
a first battery mount (31B) to which a first battery pack (33B) is attachable;
a second battery mount (32B) to which a second battery pack (34B) is attachable; and
a body housing (2B) accommodating the brushless motor (10A), the body housing (2B) having, in a direction parallel to Y-axis being orthogonal to X-axis, an end in a negative Y-direction located farther in the negative Y-direction than an end of the first battery pack (33B) in the negative Y-direction and an end of the second battery pack (34B) in the negative Y-direction and an end in a positive Y-direction located farther in the positive Y-direction than an end of the first battery pack (33B) in the positive Y-direction and an end of the second battery pack (34B) in the positive Y-direction.

An eleventh aspect of the present disclosure provides a power tool (1A), comprising:
a brushless motor (10A);
a grip (23) located rearward from the brushless motor (10A);
an output unit (16A) drivable by the brushless motor (10A), the output unit (16A) being located frontward from the brushless motor (10A);
a first battery mount (31A) to which a first battery pack (33A) is attachable, the first battery mount (31A) being located rearward from the brushless motor (10A); and
a second battery mount (32A) to which a second battery pack (34A) is attachable, the second battery mount (32A) being located frontward from the brushless motor (10A).

A twelfth aspect of the present disclosure provides a power tool (1A), comprising: a brushless motor (10A);
a grip (23) located rearward from the brushless motor (10A);
an output unit (16A) drivable by the brushless motor (10A), the output unit (16A) being located frontward from the brushless motor (10A);
a first battery mount (31A) to which a first battery pack (33A) is attachable in a manner slidable in a front-rear direction; and
a second battery mount (32A) to which a second battery pack (34A) is attachable in a manner slidable in a direction orthogonal to the front-rear direction, the second battery mount (32A) being adjacent to the first battery mount (31A).

Although one or more embodiments of the present disclosure will now be described with reference to the drawings, the present disclosure is not limited to the present embodiments. The components in the embodiments described below may be combined as appropriate. One or more components may be eliminated.

In the embodiments, the positional relationship between the components of an impact wrench will be described using the XYZ orthogonal coordinate system. A direction parallel to X-axis (first axis) on a predetermined plane is referred to as X-direction. A direction parallel to Y-axis (second axis) on a predetermined plane orthogonal to X-axis is referred to as Y-direction. A direction parallel to Z-axis (third axis) orthogonal to the predetermined plane is referred to as Z-direction. A rotation direction about X-axis or a direction oblique to X-axis is referred to as OX-direction. A rotation direction about Y-axis or a direction oblique to Y-axis is referred to as OY-direction. A rotation direction about Z-axis or a direction oblique to Z-axis is referred to as OZ-direction. In the embodiments, X-direction is the front-rear direction, Y-direction is the lateral direction, and Z-direction is the vertical direction. The positive X-direction is frontward. The negative X-direction is rearward. The positive Y-direction is leftward. The negative Y-direction is rightward. The positive Z-direction is upward. The negative Z-direction is downward.

In the embodiments, 1 Nm as a unit of torque can be converted to 0.7376 ft-lb, and 1 ft·lb can be converted to 1.36 Nm.

### First Embodiment

### Impact Wrench

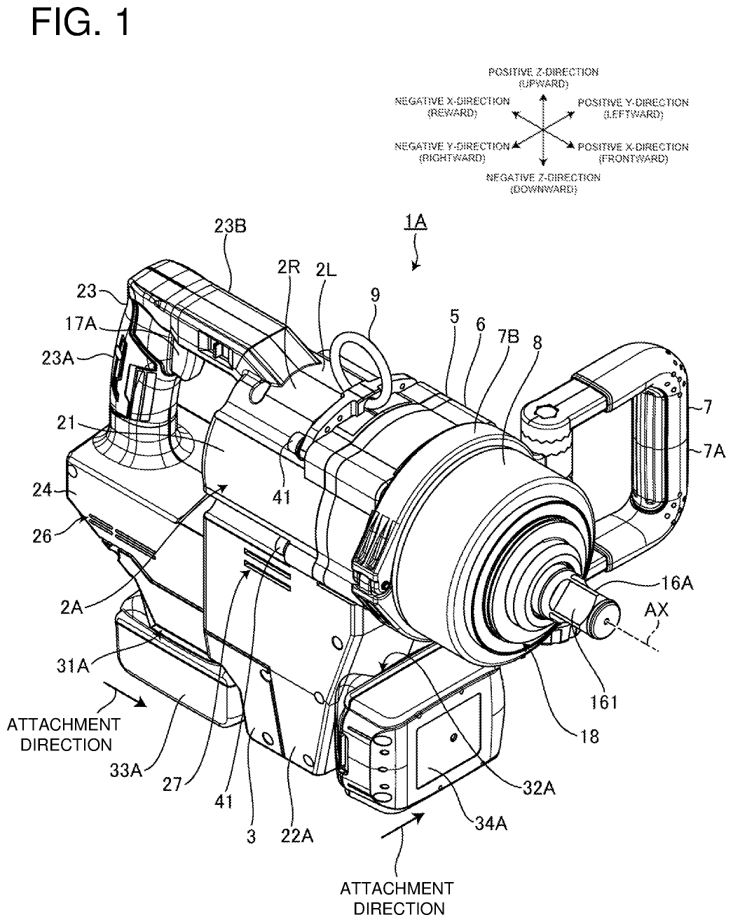

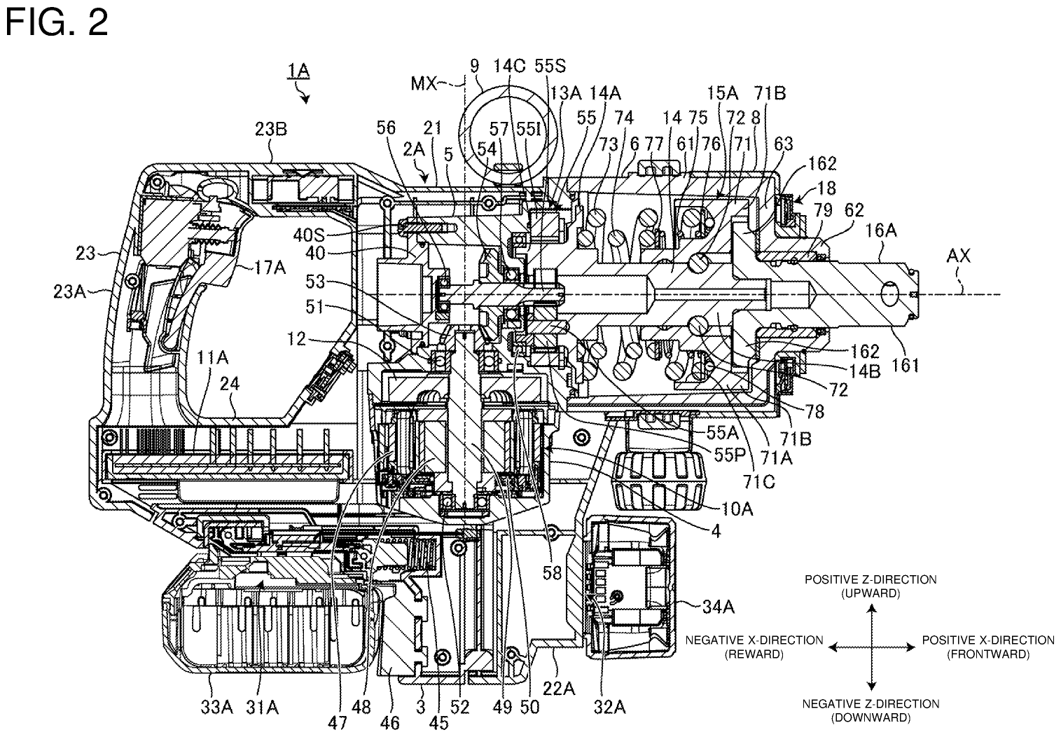

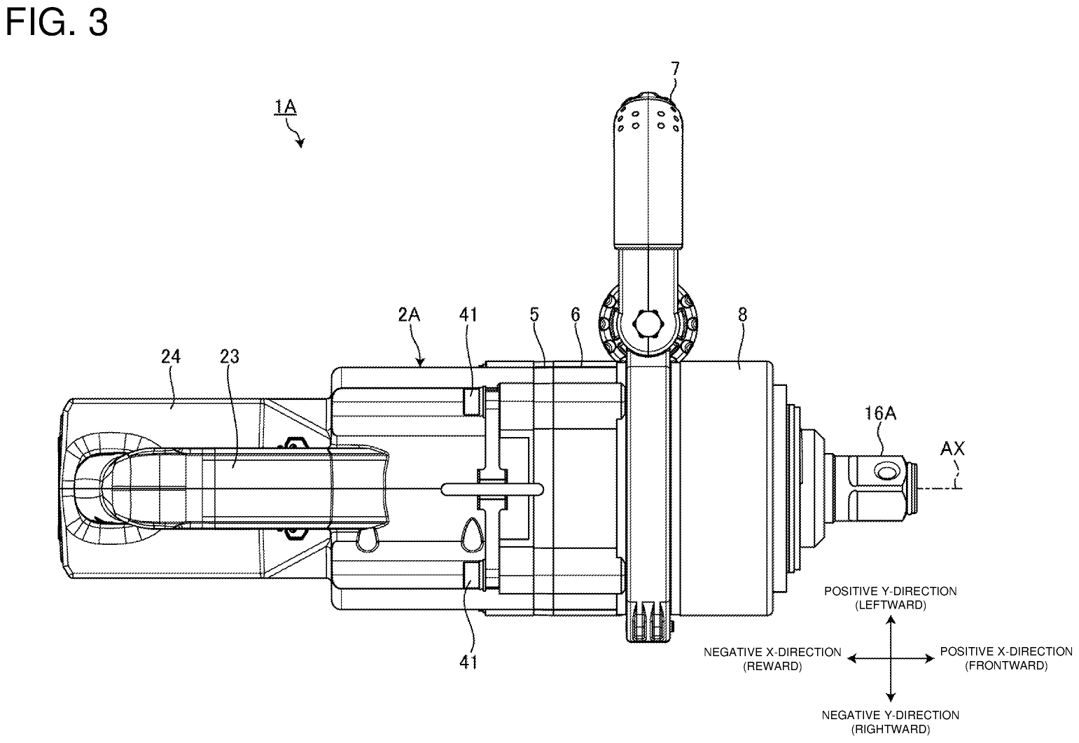

FIG. 1 is a perspective view of an impact wrench 1A according to a first embodiment. FIG. 2 is a sectional view of the impact wrench 1A. FIG. 3 is a top view of the impact wrench 1A.

The impact wrench 1A includes a body housing 2A, a first battery connector housing 3, a motor case 4, a gear case 5, a hammer case 6, a side handle 7, a bumper 8, a first battery mount 31A, a second battery mount 32A, a motor 10A, a controller 11A, a fan 12, a reducer 13A, a spindle 14, a striker 15A, an anvil 16A, a trigger switch 17A, a light assembly 18, and a hanging ring 9.

The body housing 2A accommodates the motor case 4. The body housing 2A accommodates a part of the gear case 5. The body housing 2A is fixed to the hammer case 6.

The body housing 2A is formed from a synthetic resin. Examples of the synthetic resin for the body housing 2A include a nylon resin. The body housing 2A includes a left body housing 2L and a right body housing 2R. The right body housing 2R is located on the right of the left body housing 2L. The left body housing 2L and the right body housing 2R form a pair of housing halves. The left body housing 2L and the right body housing 2R are fastened together with multiple screws.

The body housing 2A includes a body 21, a second battery connector housing 22A, a grip 23, and a controller compartment 24.

The body 21 accommodates the motor case 4. The body 21 accommodates a part of the gear case 5. The hanging ring 9 is located in an upper portion of the body 21. The hanging ring 9 is fastened to the hammer case 6 with screws 41. The hanging ring 9 may be fastened to the gear case 5 with screws.

The second battery connector housing 22A protrudes downward from the body 21. The second battery connector housing 22A is located frontward from the first battery connector housing 3.

The grip 23 is grippable by an operator. The grip 23 is located rearward from the body 21. The grip 23 includes a rear grip 23A and an upper grip 23B. The rear grip 23A extends upward from a rear portion of the controller compartment 24. The upper grip 23B extends frontward from the upper end of the rear grip 23A. The rear grip 23A has its lower end connected to the controller compartment 24. The rear grip 23A has its upper end connected to the rear end of the upper grip 23B. The upper grip 23B has its front end connected to the upper portion of the body 21. The grip 23, the body 21, and the controller compartment 24 together form a D-shaped handle. The D-shaped handle is located rearward from the motor 10A. The trigger switch 17A is located in an upper portion of the rear grip 23A.

The controller compartment 24 accommodates the controller 11A.

The first battery connector housing 3 supports the first battery mount 31A. The first battery connector housing 3 is connected to the body housing 2A in a manner movable relative to the body housing 2A. The first battery connector housing 3 is formed from a synthetic resin. Examples of the synthetic resin for the first battery connector housing 3 include a nylon resin.

The first battery connector housing 3 is located below the controller compartment 24. The first battery connector housing 3 is located rearward from the second battery connector housing 22A. The first battery connector housing 3 is connected to the D-shaped handle.

The motor case 4 accommodates the motor 10A. The motor case 4 is located below the gear case 5. The motor case 4 is fixed to the gear case 5.

The motor case 4 is formed from a synthetic resin. Examples of the synthetic resin for the motor case 4 include a polycarbonate resin.

The gear case 5 accommodates at least a part of the reducer 13A. The gear case 5 is located rearward from the hammer case 6. The gear case 5 is fixed to the hammer case 6.

The gear case 5 is formed from a metal. Examples of the metal for the gear case 5 include aluminum and magnesium.

The gear case 5 is substantially cylindrical. The gear case 5 has an opening in its front portion. The gear case 5 has an opening in its rear portion. The gear case 5 has an opening in its lower portion. The opening in the rear portion of the gear case 5 receives a bearing cover 40. The bearing cover 40 is fastened to the rear portion of the gear case 5 with a screw 40S.

The hammer case 6 accommodates the striker 15A including a hammer 71. The hammer case 6 is connected to a front portion of the body housing 2A. The hammer case 6 is connected to the front portion of the gear case 5.

The hammer case 6 is formed from a metal. Examples of the metal for the hammer case 6 include aluminum.

The hammer case 6 is substantially cylindrical. The hammer case 6 includes a first cylinder 61, a second cylinder 62, and a front wall 63. The first cylinder 61 surrounds the striker 15A including the hammer 71. The second cylinder 62 is located frontward from the first cylinder 61. The second cylinder 62 has a smaller outer diameter than the first cylinder 61. The gear case 5 has its front end received in an opening at the rear end of the first cylinder 61. The front wall 63 connects the front end of the first cylinder 61 and the rear end of the second cylinder 62.

The body housing 2A, the gear case 5, and the hammer case 6 are fastened together with the multiple screws 41.

The motor case 4 has an opening in its upper portion. The gear case 5 has the opening in its lower portion. The motor case 4 has an internal space connecting with an internal space of the gear case 5 through the opening in the upper portion of the motor case 4 and the opening in the lower portion of the gear case 5. The motor case 4 and the gear case 5 are fastened together with multiple screws (not shown).

The gear case 5 has the opening in its front portion. The hammer case 6 has an opening in its rear portion. The gear case 5 has the inner space connecting with an inner space of the hammer case 6 through the opening in the front portion of the gear case 5 and the opening in the rear portion of the hammer case 6.

The side handle 7 is grippable by the operator. The side handle 7 includes a handle portion 7A and a base 7B. The handle portion 7A is grippable by the operator. The base 7B is fixed to the hammer case 6. The handle portion 7A is located on the left of the hammer case 6. The handle portion 7A may be at any position around the hammer case 6. The handle portion 7A may be located, for example, on the right of, above, or below the hammer case 6. The handle portion 7A is located with respect to the hammer case 6 at an angle adjustable within the range of 360 degrees.

The bumper 8 covers at least a part of a surface of the hammer case 6. The bumper 8 in the present embodiment covers a surface of the first cylinder 61. The bumper 8 protects the hammer case 6. The bumper 8 reduces contact between the hammer case 6 and objects surrounding the impact wrench 1A. The bumper 8 is formed from an elastic material more flexible than the material for the hammer case 6. Examples of the elastic material for the bumper 8 include styrene-butadiene rubber.

The first battery mount 31A receives a first battery pack 33A. The first battery pack 33A is slid forward from the rear of the first battery mount 31A to be detachably attached to the first battery mount 31A. The controller compartment 24 is located above the first battery pack 33A attached to the first battery mount 31A. The second battery connector housing 22A is located frontward from the first battery pack 33A attached to the first battery mount 31A.

The first battery mount 31A includes a terminal. When the first battery pack 33A is attached to the first battery mount 31A, a battery terminal that is a connection terminal on the first battery pack 33A is connected to a first body terminal on the first battery mount 31A. The first body terminal extends in the front-rear direction. The first body terminal is supported by the first battery connector housing 3 as one of the housing halves.

The second battery mount 32A is located in front of the second battery connector housing 22A. The second battery mount 32A is located below the hammer case 6. A second battery pack 34A is slid leftward from the right of the second battery mount 32A to be detachably attached to the second battery mount 32A.

The second battery mount 32A includes a second body terminal. When the second battery pack 34A is attached to the second battery mount 32A, a battery terminal that is a connection terminal on the second battery pack 34A is connected to the second body terminal on the second battery mount 32A. The second body terminal extends in the lateral direction. The second body terminal is supported by the second battery connector housing 22A as the other of the housing halves.

The first battery pack 33A and the second battery pack 34A each serve as a power supply for the impact wrench 1A. The first battery pack 33A includes a secondary battery. The first battery pack 33A in the present embodiment includes a rechargeable lithium-ion battery. The second battery pack 34A includes a secondary battery. The second battery pack 34A in the present embodiment includes a rechargeable lithium-ion battery. The first battery pack 33A is attached to the first battery mount 31A to supply power to the impact wrench 1A. The second battery pack 34A is attached to the second battery mount 32A to supply power to the impact wrench 1A. The motor 10A is driven with the power supplied from the first battery pack 33A and the second battery pack 34A. The controller 11A operates on the power supplied from the first battery pack 33A and the second battery pack 34A.

The hanging ring 9 is located between the first battery pack 33A and the second battery pack 34A in the front-rear direction. This improves the balance of the impact wrench 1A driven by the two battery packs, or the first battery pack 33A and the second battery pack 34A, when the hanging ring 9 hangs the impact wrench 1A on a target object for hanging. This improves the balance of any power tool, in addition to the impact wrench.

The motor 10A is located between the first battery pack 33A and the second battery pack 34A in the front-rear direction. In the present embodiment, the first battery mount 31A, to which the first battery pack 33A is attached, is located rearward from the motor 10A. The second battery mount 32A, to which the second battery pack 34A is attached, is located frontward from the motor 10A. The motor 10A as a heavy component and the two battery packs, or the first battery pack 33A and the second battery pack 34A, are aligned in the front-rear direction, thus improving the balance.

The first battery connector housing 3 holds a spring 45 and a rubber buffer 46. The spring 45 is located frontward from the first battery mount 31A. The rubber buffer 46 is located frontward from the first battery pack 33A attached to the first battery mount 31A. The spring 45 urges the first battery mount 31A rearward. The rubber buffer 46 can come in contact with a front portion of the first battery pack 33A. When, for example, the impact wrench 1A is dropped, shock to the first battery mount 31A is reduced under an elastic force from the spring 45, and shock to the first battery pack 33A is reduced by the rubber buffer 46.

Although not shown in detail, the second battery connector housing 22A receiving the second battery mount 32A has the same structure as the first battery connector housing 3. In other words, the second battery connector housing 22A holds a spring and a rubber buffer. The spring is located rearward from the second battery mount 32A. The rubber buffer is located rearward from the second battery pack 34A attached to the second battery mount 32A. The spring urges the second battery mount 32A forward. The rubber buffer can come in contact with a rear portion of the second battery pack 34A. When, for example, the impact wrench 1A is dropped, shock to the second battery mount 32A is reduced under an elastic force from the spring, and shock to the second battery pack 34A is reduced by the rubber buffer.

The motor 10A serves as a power supply for the impact wrench 1A. The motor 10A is an inner-rotor direct current (DC) brushless motor. The motor 10A is accommodated in the motor case 4. The motor case 4 is accommodated in the body 21 in the body housing 2A. The body 21 in the body housing 2A accommodates the motor 10A in the motor case 4.

The motor 10A includes a stator 47, a rotor 48, and a rotor shaft 49. The stator 47 is nonrotatably fixed to the motor case 4. The rotor 48 is at least partially located inward from the stator 47. The rotor shaft 49 is fixed to the rotor 48. The rotor 48 is rotatable relative to the stator 47 about a motor rotation axis MX extending in the vertical direction (Z-direction).

The stator 47 includes a stator core and multiple coils. The stator core includes multiple teeth. The coils are wound around the multiple teeth on the stator core with insulators in between. The multiple coils are connected to one another with a busbar unit.

The rotor 48 rotates about the motor rotation axis MX. The rotor 48 includes a rotor core and a rotor magnet. The rotor magnet is fixed in the rotor core.

A sensor board 50 is fixed to the insulator on the stator 47. The sensor board 50 detects the position of the rotor 48 in the rotation direction. The sensor board 50 includes a rotation detector supported on an annular circuit board. The rotation detector detects the position of the rotor magnet in the rotor 48 to detect the position of the rotor 48 in the rotation direction.

The rotor shaft 49 is fixed to the rotor core in the rotor 48. The rotor 48 and the rotor shaft 49 rotate together about the motor rotation axis MX.

The rotor shaft 49 is rotatably supported by a rotor bearing 51 and a rotor bearing 52. The rotor shaft 49 includes an upper portion protruding upward from the upper end face of the rotor 48, and the upper portion is rotatably supported by the rotor bearing 51. The rotor shaft 49 includes a lower portion protruding downward from the lower end face of the rotor 48, and the lower portion is rotatably supported by the rotor bearing 52. The rotor bearing 51 is held by the gear case 5. The rotor bearing 52 is held by the motor case 4.

The rotor shaft 49 has its upper end fixed to a first bevel gear 53. The first bevel gear 53 is connected to at least a part of the reducer 13A. The rotor shaft 49 is connected to the reducer 13A with the first bevel gear 53.

The controller 11A outputs control signals for controlling the motor 10A. The controller 11A includes a circuit board on which multiple electronic components are mounted. Examples of the electronic components mounted on the circuit board include a processor such as a central processing unit (CPU), a nonvolatile memory such as a read-only memory (ROM) or a storage device, a volatile memory such as a random-access memory (RAM), a field-effect transistor (FET), and a resistor.

The controller 11A is accommodated in the controller compartment 24.

The fan 12 generates an airflow for cooling the motor 10A and the controller 11A. The fan 12 is located above the stator 47. The fan 12 is fixed to the upper portion of the rotor shaft 49. The fan 12 is located between the rotor bearing 51 and the stator 47. The fan 12 and the rotor shaft 49 rotate together.

The controller compartment 24 has an inlet 26. The body 21 has an outlet 27 in its upper portion. As the fan 12 rotates, air outside the body housing 2A flows into the controller compartment 24 through the inlet 26 to cool the controller 11A. As the fan 12 rotates, the air passing through the internal space of the controller compartment 24 flows into the motor case 4 through a vent in a rear portion of the motor case 4 to cool the motor 10A. As the fan 12 rotates, at least part of the air passing through the internal space of the motor case 4 flows out of the motor case 4 through the outlet 27.

The reducer 13A transmits a rotational force from the motor 10A to the striker 15A through the spindle 14. The reducer 13A connects the rotor shaft 49 and the spindle 14 together. The reducer 13A rotates the spindle 14 at a lower rotational speed than the rotor shaft 49.

The reducer 13A includes a second bevel gear 54 and a planetary gear assembly 55. The second bevel gear 54 meshes with the first bevel gear 53. The planetary gear assembly 55 is driven with the rotational force from the motor 10A that has been transmitted through the second bevel gear 54.

The planetary gear assembly 55 includes a sun gear 55S, multiple planetary gears 55P, and an internal gear 55I. The planetary gears 55P surround the sun gear 55S. The internal gear 55I surrounds the planetary gears 55P. The planetary gear assembly 55 is accommodated in the gear case 5.

The second bevel gear 54 surrounds the sun gear 55S. The second bevel gear 54 is fixed to the sun gear 55S. The second bevel gear 54 and the sun gear 55S rotate together. The second bevel gear 54 and the sun gear 55S are rotatable about an output rotation axis AX extending in the front-rear direction (X-direction). The output rotation axis AX is orthogonal to the motor rotation axis MX. The sun gear 55S has its rear end supported by a gear bearing 56. The sun gear 55S includes its intermediate portion supported by a gear bearing 57. The gear bearing 56 is held by the bearing cover 40. The gear bearing 57 is held by the gear case 5. As the rotor shaft 49 rotates to rotate the first bevel gear 53, the second bevel gear 54 rotates. This rotates the sun gear 55S.

Each planetary gear 55P meshes with the sun gear 55S. The planetary gears 55P are rotatably supported by the spindle 14 with a pin 55A. The spindle 14 is rotated by the planetary gears 55P. The internal gear 55I includes internal teeth that mesh with the planetary gears 55P. The internal gear 55I is fixed to the gear case 5. The internal gear 55I includes multiple protrusions on its outer circumferential surface. The protrusions on the internal gear 55I fit into recesses on an inner circumferential surface of the gear case 5. The internal gear 55I is constantly nonrotatable relative to the gear case 5.

When the rotor shaft 49 and the first bevel gear 53 rotate as driven by the motor 10A, the second bevel gear 54 and the sun gear 55S rotate. As the sun gear 55S rotates, the planetary gears 55P revolve about the sun gear 55S. The planetary gears 55P revolve while meshing with the internal teeth on the internal gear 55I. This causes the spindle 14, which is connected to the planetary gears 55P with the pin 55A, to rotate at a lower rotational speed than the rotor shaft 49.

The spindle 14 rotates with the rotational force from the motor 10A that has been transmitted by the reducer 13A. The spindle 14 transmits the rotational force from the motor 10A, which has been transmitted through the reducer 13A, to the striker 15A. The spindle 14 is rotatable about the output rotation axis AX. The spindle 14 includes its rear portion accommodated in the gear case 5. The spindle 14 includes its front portion accommodated in the hammer case 6. The spindle 14 is at least partially located frontward from the reducer 13A. The spindle 14 is located rearward from the anvil 16A.

The spindle 14 includes a flange 14A, a spindle shaft 14B, and a protrusion 14C. The spindle shaft 14B protrudes frontward from the flange 14A. The protrusion 14C protrudes rearward from the flange 14A.

The planetary gears 55P are rotatably supported by the flange 14A and the protrusion 14C with the pin 55A. The spindle 14 is rotatably supported by a spindle bearing 58. The protrusion 14C is rotatably supported by the spindle bearing 58. The spindle bearing 58 is held by the gear case 5.

The striker 15A strikes the anvil 16A in the rotation direction about the output rotation axis AX. The striker 15A is located frontward from the motor 10A. The striker 15A is rotated by the motor 10A. The striker 15A is rotatable about the output rotation axis AX. A rotational force from the motor 10A is transmitted to the striker 15A through the reducer 13A and the spindle 14. The striker 15A strikes the anvil 16A in the rotation direction with a rotational force of the spindle 14 rotated by the motor 10A.

The striker 15A is accommodated in the first cylinder 61 in the hammer case 6. The striker 15A includes the hammer 71, balls 72, a first coil spring 73, a second coil spring 74, a third coil spring 75, a first washer 76, and a second washer 77.

The hammer 71 is located frontward from the reducer 13A. The hammer 71 surrounds the spindle shaft 14B. The hammer 71 is held by the spindle shaft 14B. The hammer 71 is rotated by the motor 10A. The balls 72 are located between the spindle shaft 14B and the hammer 71. The hammer 71 includes a cylindrical hammer body 71A and hammer projections 71B. The hammer projections 71B are located in front of the hammer body 71A. The hammer body 71A includes an annular recess 71C on the rear surface. The recess 71C is recessed frontward from the rear surface of the hammer body 71A.

The hammer 71 is rotated by the motor 10A. A rotational force from the motor 10A is transmitted to the hammer 71 through the reducer 13A and the spindle 14. The hammer 71 is rotatable together with the spindle 14 with a rotational force of the spindle 14 rotated by the motor 10A. The hammer 71 and the spindle 14 are rotatable about the output rotation axis AX.

The first washer 76 is received in the recess 71C. The first washer 76 is supported by the hammer 71 with multiple balls 78 in between. The balls 78 are located frontward from the first washer 76.

The second washer 77 is located rearward from the first washer 76 inside the recess 71C. The second washer 77 has a smaller outer diameter than the first washer 76. The second washer 77 and the hammer 71 are movable relative to each other in the front-rear direction.

The first coil spring 73 surrounds the spindle shaft 14B. The first coil spring 73 has its rear end supported by the flange 14A. The first coil spring 73 has its front end received in the recess 71C and supported by the first washer 76. The first coil spring 73 constantly generates an elastic force for moving the hammer 71 forward.

The second coil spring 74 surrounds the spindle shaft 14B. The second coil spring 74 is located radially inward from the first coil spring 73. The second coil spring 74 has its rear end supported by the flange 14A. The second coil spring 74 has its front end received in the recess 71C and supported by the second washer 77. The second coil spring 74 generates an elastic force for moving the hammer 71 forward when the hammer 71 moves backward.

The third coil spring 75 surrounds the spindle shaft 14B. The third coil spring 75 is located radially inward from the first coil spring 73. The third coil spring 75 is received in the recess 71C. The third coil spring 75 has its rear end supported by the second washer 77. The third coil spring 75 has its front end supported by the first washer 76. The third coil spring 75 generates an elastic force for moving the second coil spring 74 backward. Thus, the rear end of the second coil spring 74 is pressed against the flange 14A under an elastic force from the third coil spring 75. This restricts free movement of the second coil spring 74 relative to the flange 14A.

The balls 72 are formed from a metal such as steel. The balls 72 are located between the spindle shaft 14B and the hammer 71. The spindle 14 has a spindle groove. The spindle groove receives at least parts of the balls 72. The spindle groove is on the outer surface of the spindle shaft 14B. The hammer 71 has a hammer groove. The hammer groove receives at least parts of the balls 72. The hammer groove is on the inner surface of the hammer 71. The balls 72 are placed between the spindle groove and the hammer groove. The balls 72 can roll along the spindle groove and the hammer groove. The hammer 71 is movable together with the balls 72. The spindle 14 and the hammer 71 are movable relative to each other in a direction parallel to the output rotation axis AX and in the rotation direction about the output rotation axis AX within a movable range defined by the spindle groove and the hammer groove.

The anvil 16A rotates about the output rotation axis AX extending in the front-rear direction. The anvil 16A is an output unit of the impact wrench 1A that rotates with a rotational force from the motor 10A. The anvil 16A is at least partially located frontward from the hammer 71. The anvil 16A is strikable by the hammer 71 in the striker 15A in the rotation direction. The spindle shaft 14B has its front end received in an anvil recess on the rear end of the anvil 16A.

The anvil 16A includes an anvil shaft 161 and anvil projections 162. The anvil shaft 161 is located frontward from the striker 15A. The anvil projections 162 protrude radially outward from the rear end of the anvil shaft 161. The anvil projections 162 are strikable by the striker 15A in the rotation direction about the output rotation axis AX.

The anvil shaft 161 has its front end located frontward from the hammer case 6 through an opening in a front portion of the second cylinder 62. The anvil shaft 161 receives a socket as a tip tool at its front end.

The anvil 16A is rotatably supported by an anvil bearing 79. The anvil bearing 79 surrounds the anvil shaft 161. The anvil 16A is rotatable about the output rotation axis AX.

The anvil bearing 79 is held by the hammer case 6. The anvil bearing 79 is located inside the second cylinder 62 in the hammer case 6. The anvil bearing 79 is held by the second cylinder 62 in the hammer case 6.

The anvil bearing 79 in the present embodiment is a slide bearing. The anvil bearing 79 is cylindrical. The anvil bearing 79 in the present embodiment is a sleeve. The slide bearing may be a porous cylindrical metal body manufactured using, for example, a powder metallurgy process, and impregnated with lubricant oil.

The anvil shaft 161 has a circular outer circumference in a cross section orthogonal to the output rotation axis AX. The anvil bearing 79 has a circular inner circumference in a cross section orthogonal to the output rotation axis AX.

The anvil shaft 161 has its front end located frontward from the second cylinder 62 through the opening at the front end of the second cylinder 62. The anvil shaft 161 is at least partially received in the opening at the front end of the second cylinder 62.

The trigger switch 17A is operable by the operator to drive the motor 10A. Driving the motor 10A refers to rotating the rotor 48 in response to the coils in the stator 47 receiving a current. The trigger switch 17A is located in the upper portion of the rear grip 23A. The trigger switch 17A protrudes frontward from the upper front of the rear grip 23A. The operator operates the trigger switch 17A to move backward. In response to an operation on the trigger switch 17A, the motor 10A is driven. In response to a release operation on the trigger switch 17A, the motor 10A is stopped.

The light assembly 18 emits illumination light. The light assembly 18 illuminates the anvil 16A and an area around the anvil 16A with illumination light. The light assembly 18 illuminates an area ahead of the anvil 16A with illumination light. The light assembly 18 also illuminates the socket attached to the anvil 16A and an area around the socket with illumination light. The light assembly 18 surrounds the second cylinder 62 in the hammer case 6.

### Operation of Impact Wrench

The operation of the impact wrench 1A will now be described. In a tightening operation on a workpiece, for example, a socket for the tightening operation is attached to the front end of the anvil 16A. The operator then grips the side handle 7 with the left hand and the grip 23 with the right hand to operate the trigger switch 17A with the right index finger and the middle finger to move the trigger switch 17A backward. In response to the operation on the trigger switch 17A, power is supplied from the first battery pack 33A and the second battery pack 34A to the motor 10A to drive the motor 10A and turn on the light assembly 18. The motor 10A is driven to rotate the rotor 48 and the rotor shaft 49. The rotational force of the rotor shaft 49 is then transmitted to the planetary gears 55P through the first bevel gear 53, the second bevel gear 54, and the sun gear 55S. The planetary gears 55P revolve about the sun gear 55S while rotating and meshing with the internal teeth on the internal gear 55I. The planetary gears 55P are rotatably supported by the spindle 14 with the pin 55A. The revolving planetary gears 55P rotate the spindle 14 at a lower rotational speed than the rotor shaft 49.

When the spindle 14 rotates with the hammer projections 71B and the anvil projections 162 in contact with each other, the anvil 16A rotates together with the hammer 71 and the spindle 14. Thus, the tightening operation proceeds.

When the anvil 16A receives a predetermined or higher load as the tightening operation proceeds, the anvil 16A and the hammer 71 stop rotating. As the spindle 14 rotates in this state, the hammer 71 moves backward. Thus, the hammer projections 71B and the anvil projections 162 come out of contact with each other. The hammer 71 that has moved backward then moves forward while rotating under elastic forces from the first coil spring 73 and the second coil spring 74. Thus, the anvil 16A is struck by the hammer 71 in the rotation direction. The anvil 16A thus rotates about the output rotation axis AX at a high torque value. A bolt or a nut is thus tightened into the workpiece at a high torque value.

### Battery Mount and Battery Pack

As described above, the impact wrench 1A includes the first battery mount 31A to which the first battery pack 33A is attachable, and the second battery mount 32A to which the second battery pack 34A is attachable. The second battery mount 32A is not aligned with the first battery mount 31A in the front-rear direction (X-direction). The second battery mount 32A in the present embodiment is located frontward from the first battery mount 31A.

In the present embodiment, the first battery mount 31A is located in the first battery connector housing 3. The second battery mount 32A is located in front of the second battery connector housing 22A.

The first battery pack 33A is slid forward (in the positive X-direction) relative to the first battery mount 31A from the rear (located in the negative X-direction) to be attached to the first battery mount 31A. The second battery pack 34A is slid leftward (in the positive Y-direction) relative to the second battery mount 32A from the right (located in the negative Y-direction) to be attached to the second battery mount 32A.

As shown in FIG. 3, the body housing 2A has its right end located rightward from the right end of the first battery pack 33A and the right end of the second battery pack 34A. The body housing 2A has its left end located leftward from the left end of the first battery pack 33A and the left end of the second battery pack 34A. In other words, the first battery pack 33A does not protrude rightward from the right end of the body housing 2A. The first battery pack 33A does not protrude leftward from the left end of the body housing 2A. The second battery pack 34A does not protrude rightward from the right end of the body housing 2A. The second battery pack 34A does not protrude leftward from the left end of the body housing 2A.

The first battery pack 33A and the second battery pack 34A have the same rated voltage. The first battery pack 33A and the second battery pack 34A may each have a rated voltage of 18 or 36 V. In the present embodiment, the first battery pack 33A and the second battery pack 34A each have a rated voltage of 18 V and a maximum rated voltage of 20 V. The first battery pack 33A and the second battery pack 34A are connected in series and thus the motor 10A receives power of 36 V. For the first battery pack 33A and the second battery pack 34A each having a rated voltage of 36 V, they are connected in parallel and thus have a maximum rated voltage of 40 V.

The first battery pack 33A and the second battery pack 34A have the same outer shape and dimensions.

In other words, the first battery pack 33A and the second battery pack 34A are of the same type. With the first battery pack 33A and the second battery pack 34A having different ampere-hour (Ah) capacities, the motor 10A can be operated. For example, with the first battery pack 33A being an 18 V battery pack with 5 Ah capacity and the second battery pack 34A being an 18 V battery pack with 2 Ah capacity, the impact wrench can be operated.

The second body terminal on the first battery mount 31A has the same structure and dimensions as the second body terminal on the second battery mount 32A.

In the present embodiment, the anvil 16A has a maximum tightening torque value less than 3000 Nm. The anvil 16A has a maximum tightening torque value of 2000 to 3000 Nm inclusive. The anvil 16A may have a maximum tightening torque value of 3000 to 4000 Nm inclusive.

As described above, the impact wrench 1A according to the present embodiment includes the motor 10A as a brushless motor, the striker 15A rotatable by the motor 10A, the anvil 16A strikable by the striker 15A to rotate about the output rotation axis AX extending in the direction parallel to X-axis, the first battery mount 31A to which the first battery pack 33A is attachable, and the second battery mount 32A being not aligned with the first battery mount 31A in the direction parallel to X-axis and to which the second battery pack 34A is attachable.

This reduces the likelihood that the work efficiency is decreased.

In the present embodiment, the first battery pack 33A is slid relative to the first battery mount 31A in the direction parallel to X-axis to be attached to the first battery mount 31A. The second battery pack 34A is slid relative to the second battery mount 32A in the direction parallel to Y-axis being orthogonal to X-axis to be attached to the second battery mount 32A.

This reduces the likelihood that the work efficiency is decreased.

The impact wrench 1A according to the present embodiment includes the body housing 2A accommodating the motor 10A. In the direction parallel to Y-axis, the body housing 2A has its end in the negative Y-direction located farther in the negative Y-direction than the end of the first battery pack 33A in the negative Y-direction and the end of the second battery pack 34A in the negative Y-direction. The body housing 2A has its end in the positive Y-direction located farther in the positive Y-direction than the end of the first battery pack 33A in the positive Y-direction and the end of the second battery pack 34A in the positive Y-direction.

This reduces the likelihood that the work efficiency is decreased.

The impact wrench 1A according to the present embodiment includes the motor 10A as a brushless motor, the striker 15A rotatable by the motor 10A, the anvil 16A strikable by the striker 15A to rotate about the output rotation axis AX extending in the direction parallel to X-axis, the first battery mount 31A to which the first battery pack 33A is attachable, the second battery mount 32A to which the second battery pack 34A is attachable, and the body housing 2A accommodating the motor 10A. In the direction parallel to Y-axis being orthogonal to X-axis, the body housing 2A has its end in the negative Y-direction located farther in the negative Y-direction than the end of the first battery pack 33A in the negative Y-direction and the end of the second battery pack 34A in the negative Y-direction. The body housing 2A has its end in the positive Y-direction located farther in the positive Y-direction than the end of the first battery pack 33A in the positive Y-direction and the end of the second battery pack 34A in the positive Y-direction.

This reduces the likelihood that the work efficiency is decreased.

The hanging ring 9 in the present embodiment is located between the first battery pack 33A and the second battery pack 34A in the front-rear direction. This improves the balance of the impact wrench 1A driven by the two battery packs, or the first battery pack 33A and the second battery pack 34A, when the hanging ring 9 hangs the impact wrench 1A on a target object for hanging. This improves the balance of any power tool, in addition to the impact wrench.

The motor 10A in the present embodiment is located between the first battery pack 33A and the second battery pack 34A in the front-rear direction. In the present embodiment, the first battery mount 31A, to which the first battery pack 33A is attachable, is located rearward from the motor 10A. The second battery mount 32A, to which the second battery pack 34A is attachable, is located frontward from the motor 10A. The motor 10A as a heavy component and the two battery packs, or the first battery pack 33A and the second battery pack 34A, are aligned in the front-rear direction, thus improving the balance. This improves the balance of any power tool, in addition to the impact wrench.

The components in the present embodiment are usable in other power tools, in addition to an impact wrench. The components in the present embodiment are usable in, for example, a hammer drill, a reciprocating saw, a disc saw, or a band saw. The components in the present embodiment are also usable in an outdoor power equipment (OPE). The components in the present embodiment are usable in, for example, a hedge trimmer, a chain saw, or a blower. The same applies to the components in the embodiments described below.

### Second Embodiment

A second embodiment will be described. The same reference numerals hereafter denote the same or corresponding components as in the above embodiment, and such components will be described briefly or will not be described.

### Impact Wrench

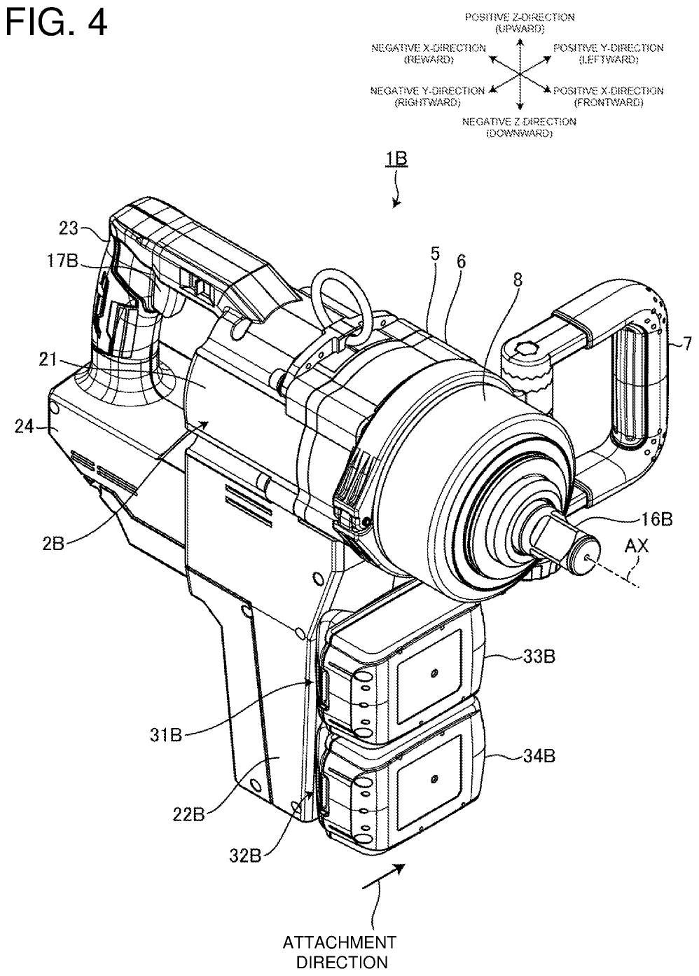

FIG. 4 is a perspective view of an impact wrench 1B according to the second embodiment. The impact wrench 1B according to the present embodiment is a modification of the impact wrench 1A according to the first embodiment.

The impact wrench 1B includes a body housing 2B, the gear case 5, the hammer case 6, the side handle 7, the bumper 8, a first battery mount 31B, a second battery mount 32B, an anvil 16B, and a trigger switch 17B.

The body housing 2B includes the body 21, a battery connector housing 22B, the grip 23, and the controller compartment 24. The body 21 accommodates the motor 10A. The battery connector housing 22B protrudes downward from the body 21.

The anvil 16B rotates about the output rotation axis AX extending in X-direction.

A first battery pack 33B is detachably attached to the first battery mount 31B. The first battery mount 31B is located in front of the battery connector housing 22B.

A second battery pack 34B is detachably attached to the second battery mount 32B. The second battery mount 32B is located in front of the battery connector housing 22B.

The second battery mount 32B in the present embodiment is adjacent to the first battery mount 31B.

The first battery mount 31B is substantially aligned with the second battery mount 32B in X-direction. The first battery mount 31B is substantially aligned with the second battery mount 32B in Y-direction. The first battery mount 31B is not aligned with the second battery mount 32B in Z-direction. The first battery mount 31B in the present embodiment is located upward (in the positive Z-direction) from the second battery mount 32B. The second battery mount 32B is adjacent to the first battery mounts 31B in Z-direction.

The first battery pack 33B is slid leftward (in the positive Y-direction) relative to the first battery mount 31B from the right (located in the negative Y-direction) to be attached to the first battery mount 31B. The second battery pack 34B is slid leftward (in the positive Y-direction) relative to the second battery mount 32B from the right (located in the negative Y-direction) to be attached to the second battery mount 32B.

The body housing 2B has its right end located rightward from the right end of the first battery pack 33B and the right end of the second battery pack 34B. The body housing 2B has its left end located leftward from the left end of the first battery pack 33B and the left end of the second battery pack 34B. In other words, the first battery pack 33B does not protrude rightward from the right end of the body housing 2B. The first battery pack 33B does not protrude leftward from the left end of the body housing 2B. The second battery pack 34B does not protrude rightward from the right end of the body housing 2B. The second battery pack 34B does not protrude leftward from the left end of the body housing 2B.

The first battery pack 33B and the second battery pack 34B have the same rated voltage. The first battery pack 33B and the second battery pack 34B may each have a rated voltage of 18 or 36 V. In the present embodiment, the first battery pack 33B and the second battery pack 34B each have a rated voltage of 36 V, and a maximum rated voltage of 40 V.

The first battery pack 33B and the second battery pack 34B have the same outer shape and dimensions.

In other words, the first battery pack 33B and the second battery pack 34B are of the same type.

The first battery mount 31B includes a body terminal that has the same structure and dimensions as a body terminal on the second battery mount 32B.

In the present embodiment, the anvil 16B has a maximum tightening torque value less than 3000 Nm.

The impact wrench 1B according to the embodiment includes the motor 10A as a brushless motor, the striker 15A rotatable by the motor 10A, the anvil 16B strikable by the striker 15A to rotate about the output rotation axis AX extending in the direction parallel to X-axis, the first battery mount 31B to which the first battery pack 33B is attachable, and the second battery mount 32B to which the second battery pack 34B is attachable and being adjacent to the first battery mount 31B. The first battery pack 33B is slid relative to the first battery mount 31B in the direction parallel to Y-axis being orthogonal to X-axis to be attached to the first battery mount 31B. The second battery pack 34B is slid relative to the second battery mount 32B in the direction parallel to Y-axis to be attached to the second battery mount 32B.

This reduces the likelihood that the work efficiency is decreased.

The impact wrench 1B according to the embodiment includes the body housing 2B accommodating the motor 10A. In the direction parallel to Y-axis, the body housing 2B has its end in the negative Y-direction located farther in the negative Y-direction than the end of the first battery pack 33B in the negative Y-direction and the end of the second battery pack 34B in the negative Y-direction. The body housing 2B has its end in the positive Y-direction located farther in the positive Y-direction than the end of the first battery pack 33B in the positive Y-direction and the end of the second battery pack 34B in the positive Y-direction.

This reduces the likelihood that the work efficiency is decreased.

The impact wrench 1B according to the embodiment includes the motor 10A as a brushless motor, the striker 15A rotatable by the motor 10A, the anvil 16B strikable by the striker 15A to rotate about the output rotation axis AX extending in the direction parallel to X-axis, the first battery mount 31B to which the first battery pack 33B is attachable, the second battery mount 32B to which the second battery pack 34B is attachable, and the body housing 2B accommodating the motor 10A. In the direction parallel to Y-axis being orthogonal to X-axis, the body housing 2B has its end in the negative Y-direction located farther in the negative Y-direction than the end of the first battery pack 33B in the negative Y-direction and the end of the second battery pack 34B in the negative Y-direction. The body housing 2B has its end in the positive Y-direction located farther in the positive Y-direction than the end of the first battery pack 33B in the positive Y-direction and the end of the second battery pack 34B in the positive Y-direction.

This reduces the likelihood that the work efficiency is decreased.

### Third Embodiment

A third embodiment will be described. The same reference numerals hereafter denote the same or corresponding components as in the above embodiments, and such components will be described briefly or will not be described.

### Impact Wrench

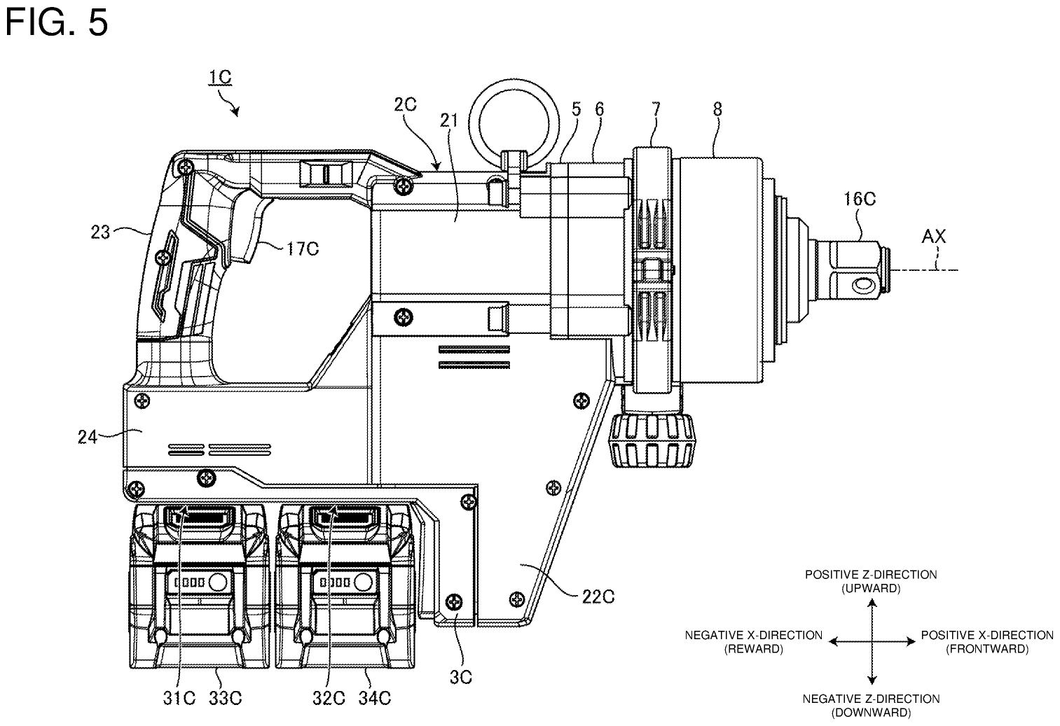

FIG. 5 is a side view of an impact wrench 1C according to the third embodiment. The impact wrench 1C according to the present embodiment is a modification of the impact wrench 1A according to the first embodiment.

The impact wrench 1C includes a body housing 2C, a battery connector housing 3C, the gear case 5, the hammer case 6, the side handle 7, the bumper 8, a first battery mount 31C, a second battery mount 32C, an anvil 16C, and a trigger switch 17C.

The body housing 2C includes the body 21, a protrusion 22C, the grip 23, and the controller compartment 24. The body 21 accommodates the motor 10A. The protrusion 22C protrudes downward from the body 21.

The anvil 16C rotates about the output rotation axis AX extending in X-direction.

A first battery pack 33C is detachably attached to the first battery mount 31C. The first battery mount 31C is located on the battery connector housing 3C.

A second battery pack 34C is detachably attached to the second battery mount 32C. The second battery mount 32C is located on the battery connector housing 3C.

The second battery mount 32C in the present embodiment is adjacent to the first battery mount 31C.

The first battery mount 31C is not aligned with the second battery mount 32C in X-direction. The first battery mount 31C in the present embodiment is located rearward (in the negative X-direction) from the second battery mount 32C. The second battery mount 32C is adjacent to the first battery mount 31C in X-direction. The first battery mount 31C is substantially aligned with the second battery mount 32C in Y-direction. The first battery mount 31C is substantially aligned with the second battery mount 32C in Z-direction.

The first battery pack 33C is slid leftward (in the positive Y-direction) relative to the first battery mount 31C from the right (located in the negative Y-direction) to be attached to the first battery mount 31C. The second battery pack 34C is slid leftward (in the positive Y-direction) relative to the second battery mount 32C from the right (located in the negative Y-direction) to be attached to the second battery mount 32C.

The body housing 2C has its right end located rightward from the right end of the first battery pack 33C and the right end of the second battery pack 34C. The body housing 2C has its left end located leftward from the left end of the first battery pack 33C and the left end of the second battery pack 34C. In other words, the first battery pack 33C does not protrude rightward from the right end of the body housing 2C. The first battery pack 33C does not protrude leftward from the left end of the body housing 2C. The second battery pack 34C does not protrude rightward from the right end of the body housing 2C. The second battery pack 34C does not protrude leftward from the left end of the body housing 2C.

The first battery pack 33C and the second battery pack 34C have the same rated voltage. The first battery pack 33C and the second battery pack 34C may each have a rated voltage of 18 or 36 V. In the present embodiment, the first battery pack 33C and the second battery pack 34C each have a rated voltage of 36 V, and a maximum rated voltage of 40 V. The motor may receive power of 72 or 36 V. For the first battery pack 33C and the second battery pack 34C each having a rated voltage of 18 V, they have a maximum rated voltage of 20 V.

The first battery pack 33C and the second battery pack 34C have the same outer shape and dimensions.

In other words, the first battery pack 33C and the second battery pack 34C are of the same type.

The first battery mount 31C and the second battery mount 32C include terminals with the same structure and dimensions.

In the present embodiment, the anvil 16C has a maximum tightening torque value less than 3000 Nm. The anvil 16C has a maximum tightening torque value of 2000 to 3000 Nm inclusive. The anvil 16C may have a maximum tightening torque value of 3000 to 4000 Nm inclusive.

The impact wrench 1A, 1B, or 1C according to each embodiment has the specifications below.
The total rated voltage of the battery packs: greater than or equal to 36 V
The outer diameter of the stator core: greater than or equal to 80 mm (140 mm at maximum)
The maximum tightening torque value of the anvil: about 3000 Nm (or may also be 2000 to 3000 Nm inclusive, or 3000 to 4000 Nm inclusive)
The striking speed of the striker: 900 rpm (or may also be 700 to 1500 rpm inclusive)
The unloaded rotational speed of the anvil: 685 rpm (or may also be 500 to 1000 rpm inclusive)
The deceleration ratio of the reducer: 1/33.7 (or may be within the range of 1/25 to 1/40)
The weight of the hammer: 1.3 kg (or may also be 1 to 1.5 kg inclusive)
The length of a side of the socket mount in the anvil: 1 inch (or may also be 0.5 to 1.5 inches inclusive)
The outer dimensions of the impact wrench without the battery pack attached: 197 mm in Z-direction, 130 mm in Y-direction, and 456 mm in X-direction (or may be 180 to 210 mm inclusive in Z-direction, 110 to 140 mm inclusive in Y-direction, and 400 to 500 mm inclusive in X-direction)
The weight of the impact wrench without the battery pack attached: 10 kg (or may also be 7 to 13 kg inclusive)

As described above, the impact wrench 1C according to the present embodiment includes the motor 10A as a brushless motor, the striker 15A rotatable by the motor 10A, the anvil 16C strikable by the striker 15A to rotate about the output rotation axis AX extending in the direction parallel to X-axis, the first battery mount 31C to which the first battery pack 33C is attachable, and the second battery mount 32C to which the second battery pack 34C is attachable and being not aligned with the first battery mount 31C in the direction parallel to X-axis.

This reduces the likelihood that the work efficiency is decreased.

The impact wrench 1C according to the embodiment includes the body housing 2C accommodating the motor 10A. In the direction parallel to Y-axis, the body housing 2C has its end in the negative Y-direction located farther in the negative Y-direction than the end of the first battery pack 33C in the negative Y-direction and the end of the second battery pack 34C in the negative Y-direction. The body housing 2C has its end in the positive Y-direction farther in the positive Y-direction than the end of the first battery pack 33C in the positive Y-direction and the end of the second battery pack 34C in the positive Y-direction.

This reduces the likelihood that the work efficiency is decreased.

The first battery pack 33C in the embodiment is slid relative to the first battery mount 31C in the direction parallel to Y-axis being orthogonal to X-axis, or from the end in the negative Y-direction toward the end in the positive Y-direction, to be attached to the first battery mount 31C. The second battery pack 34C is slid relative to the second battery mount 32C in the direction parallel to Y-axis, or from the end in the negative Y-direction toward the end in the positive Y-direction, to be attached to the second battery mount 32C.

This reduces the likelihood that the work efficiency is decreased.

The impact wrench 1C according to the embodiment includes the motor 10A as a brushless motor, the striker 15A rotatable by the motor 10A, the anvil 16C strikable by the striker 15A to rotate about the output rotation axis AX extending in the direction parallel to X-axis, the first battery mount 31C to which the first battery pack 33C is attachable, and the second battery mount 32C to which the second battery pack 34C is attachable and being adjacent to the first battery mount 31C. The first battery pack 33C is slid relative to the first battery mount 31C in the direction parallel to Y-axis being orthogonal to X-axis, or from the end in the negative Y-direction toward the end in the positive Y-direction, to be attached to the first battery mount 31C. The second battery pack 34C is slid relative to the second battery mount 32C in the direction parallel to Y-axis, or from the end in the negative Y-direction toward the end in the positive Y-direction, to be attached to the second battery mount 32C.

This reduces the likelihood that the work efficiency is decreased.

### Fourth Embodiment

A fourth embodiment will be described. The same reference numerals hereafter denote the same or corresponding components as in the above embodiments, and such components will be described briefly or will not be described.

### Impact Wrench

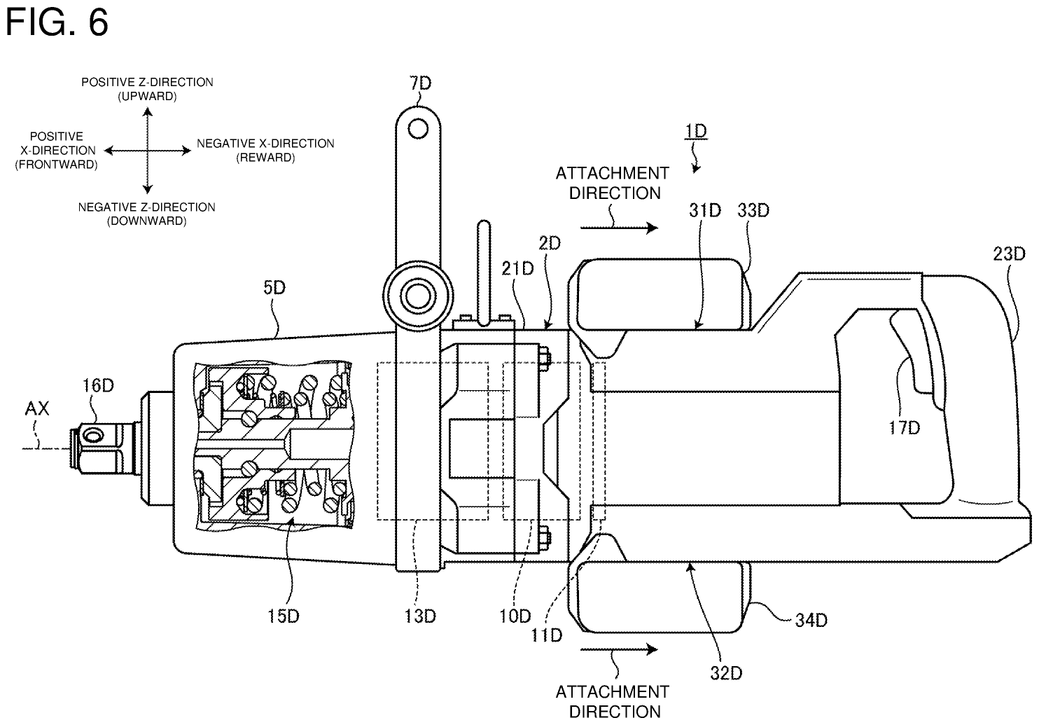

FIG. 6 is a side view of an impact wrench 1D according to the fourth embodiment.

The impact wrench 1D includes a body housing 2D, a gear case 5D, a handle 7D, a controller 11D, a motor 10D, a reducer 13D, a striker 15D, an anvil 16D, a trigger switch 17D, a first battery mount 31D, and a second battery mount 32D.

The body housing 2D includes a body 21D and a grip 23D. The body 21D accommodates the motor 10D. The grip 23D is located in a rear portion of the body 21D. The trigger switch 17D is located on the grip 23D.

In the present embodiment, the motor 10D has its motor rotation axis extending in the front-rear direction (X-direction). The motor 10D includes a rotor rotatable about the motor rotation axis extending in the front-rear direction. The output rotation axis AX also extends in the front-rear direction. The motor rotation axis aligns with the output rotation axis AX.

The controller 11D is located rearward from the motor 10D. The reducer 13D is located frontward from the motor 10D. The striker 15D is located frontward from the reducer 13D. The anvil 16D is strikable by the striker 15D in the rotation direction. The anvil 16D rotates about the output rotation axis AX extending in X-direction.

The handle 7D protrudes upward from the gear case 5D or the body 21D.

The first battery mount 31D is located in an upper portion of the body housing 2D. A first battery pack 33D is detachably attached to the first battery mount 31D.

The second battery mount 32D is located in a lower portion of the body housing 2D. A second battery pack 34D is detachably attached to the second battery mount 32D.

The first battery mount 31D is substantially aligned with the second battery mount 32D in X-direction. The first battery mount 31D is substantially aligned with the second battery mount 32D in Y-direction. The first battery mount 31D is not aligned with the second battery mount 32D in Z-direction. The first battery mount 31D in the present embodiment is located upward (in the positive Z-direction) from the second battery mount 32D.

The first battery pack 33D is slid rearward (in the negative X-direction) relative to the first battery mount 31D from the front (located in the positive X-direction) to be attached to the first battery mount 31D. The second battery pack 34D is slid rearward (in the negative X-direction) relative to the second battery mount 32D from the front (located in the positive X-direction) to be attached to the second battery mount 32D.

The first battery pack 33D may be slid forward relative to the first battery mount 31D from the rear to be attached to the first battery mount 31D. The second battery pack 34D may be slid forward relative to the second battery mount 32D from the rear to be attached to the second battery mount 32D.

The body housing 2D has its right end located rightward from the right end of the first battery pack 33D and the right end of the second battery pack 34D. The body housing 2D has its left end located leftward from the left end of the first battery pack 33D and the left end of the second battery pack 34D. In other words, the first battery pack 33D does not protrude rightward from the right end of the body housing 2D. The first battery pack 33D does not protrude leftward from the left end of the body housing 2D. The second battery pack 34D does not protrude rightward from the right end of the body housing 2D. The second battery pack 34D does not protrude leftward from the left end of the body housing 2D.

The first battery pack 33D and the second battery pack 34D have the same rated voltage. The first battery pack 33D and the second battery pack 34D may each have a rated voltage of 18 or 36 V. In the present embodiment, the first battery pack 33D and the second battery pack 34D each have a rated voltage of 18 V, and a maximum rated voltage of 20 V. The first battery pack 33D and the second battery pack 34D are connected in series and thus the motor receives power of 36 V.

The first battery pack 33D and the second battery pack 34D have the same outer shape and dimensions.

In other words, the first battery pack 33D and the second battery pack 34D are of the same type.

The first battery mount 31D and the second battery mount 32D include terminals with the same structure and dimensions.

In the present embodiment, the anvil 16D has a maximum tightening torque value less than 3000 Nm. The anvil 16D may have a maximum tightening torque value of 2000 to 4000 Nm inclusive.

The impact wrench 1D according to the present embodiment has the specifications below.
The total rated voltage of the battery packs: about greater than or equal to 36 V
The outer diameter of the stator core: greater than or equal to 80 mm (140 mm at maximum)
The maximum tightening torque value of the anvil: about 3000 Nm (or may also be 2000 to 3000 Nm inclusive, or 3000 to 4000 Nm inclusive)
The striking speed of the striker: 900 rpm (or may also be 700 to 1500 rpm inclusive)
The unloaded rotational speed of the anvil: 685 rpm (or may also be 500 to 1000 rpm inclusive)
The deceleration ratio of the reducer: 1/33.7 (or may be within the range of 1/25 to 1/40)
The weight of the hammer: 1.3 kg (or may also be 1 to 1.5 kg inclusive)
The length of a side of the socket mount in the anvil: 1 inch (or may also be 0.5 to 1.5 inches inclusive)
The outer dimensions of the impact wrench without the battery pack attached: 197 mm in Z-direction, 130 mm in Y-direction, and 456 mm in X-direction (or may be 180 to 210 mm inclusive in Z-direction, 110 to 140 mm inclusive in Y-direction, and 400 to 500 mm inclusive in X-direction)
The weight of the impact wrench without the battery pack attached: 10 kg (or may also be 7 to 13 kg inclusive)

As described above, the impact wrench 1D according to the embodiment includes the motor 10D as a brushless motor, the striker 15D rotatable by the motor 10D, the anvil 16D strikable by the striker 15D to rotate about the output rotation axis AX extending in the direction parallel to X-axis, the first battery mount 31D to which the first battery pack 33D is attachable, the second battery mount 32D to which the second battery pack 34D is attachable, and the body housing 2D accommodating the motor 10D. In the direction parallel to Y-axis being orthogonal to X-axis, the body housing 2D has its end in the negative Y-direction located farther in the negative Y-direction than the end of the first battery pack 33D in the negative Y-direction and the end of the second battery pack 34D in the negative Y-direction. The body housing 2D has its end in the positive Y-direction located farther in the positive Y-direction than the end of the first battery pack 33D in the positive Y-direction and the end of the second battery pack 34D in the positive Y-direction.

This reduces the likelihood that the work efficiency is decreased.

### Fifth Embodiment

A fifth embodiment will be described. The same reference numerals hereafter denote the same or corresponding components as in the above embodiments, and such components will be described briefly or will not be described.

### Impact Wrench

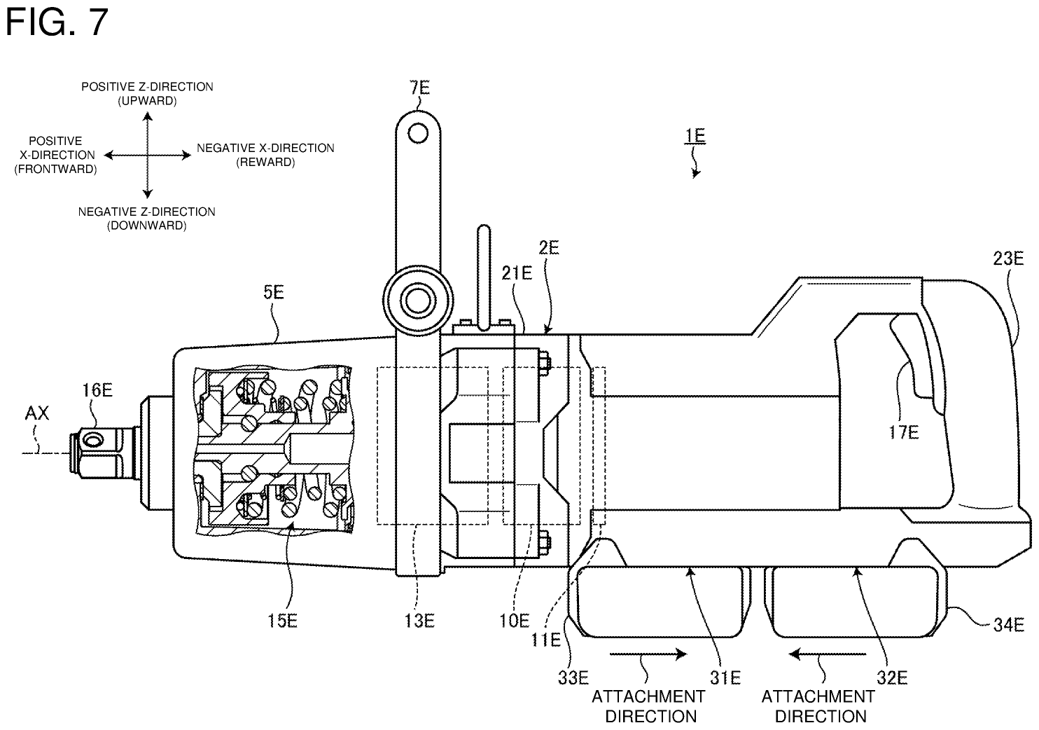

FIG. 7 is a side view of an impact wrench 1E according to the fifth embodiment. The impact wrench 1E according to the present embodiment is a modification of the impact wrench 1D according to the fourth embodiment.

The impact wrench 1E includes a body housing 2E, a gear case 5E, a handle 7E, a controller 11E, a motor 10E, a reducer 13E, a striker 15E, an anvil 16E, a trigger switch 17E, a first battery mount 31E, and a second battery mount 32E.

The body housing 2E includes a body 21E and a grip 23E. The body 21E accommodates the motor 10E. The grip 23E is located in a rear portion of the body 21E. The trigger switch 17E is located on the grip 23E.

The motor 10E includes a rotor rotatable about the motor rotation axis extending in the front-rear direction. The output rotation axis AX also extends in the front-rear direction. The motor rotation axis aligns with the output rotation axis AX.

The controller 11E is located rearward from the motor 10E. The reducer 13E is located frontward from the motor 10E. The striker 15E is located frontward from the reducer 13E. The anvil 16E is strikable by the striker 15E in the rotation direction. The anvil 16E rotates about the output rotation axis AX extending in X-direction.

The handle 7E protrudes upward from the gear case 5E or the body 21E.

A first battery pack 33E is detachably attached to the first battery mount 31E. The first battery mount 31E is located in a lower portion of the body housing 2E.

A second battery pack 34E is detachably attached to the second battery mount 32E. The second battery mount 32E is located in a lower portion of the body housing 2E.

The first battery mount 31E is not aligned with the second battery mount 32E in X-direction. The first battery mount 31E in the present embodiment is located frontward (in the positive X-direction) from the second battery mount 32E. The first battery mount 31E is substantially aligned with the second battery mount 32E in Y-direction. The first battery mount 31E is substantially aligned with the second battery mount 32E in Z-direction.

The first battery pack 33E is slid rearward (in the negative X-direction) relative to the first battery mount 31E from the front (located in the positive X-direction) to be attached to the first battery mount 31E. The second battery pack 34E is slid forward (in the positive X-direction) relative to the second battery mount 32E from the rear (located in the negative X-direction) to be attached to the second battery mount 32E.

The body housing 2E has its right end located rightward from the right end of the first battery pack 33E and the right end of the second battery pack 34E. The body housing 2E has its left end located leftward from the left end of the first battery pack 33E and the left end of the second battery pack 34E. In other words, the first battery pack 33E does not protrude rightward from the right end of the body housing 2E. The first battery pack 33E does not protrude leftward from the left end of the body housing 2E. The second battery pack 34E does not protrude rightward from the right end of the body housing 2E. The second battery pack 34E does not protrude leftward from the left end of the body housing 2E.

The first battery pack 33E and the second battery pack 34E have the same rated voltage. The first battery pack 33E and the second battery pack 34E may each have a rated voltage of 18 or 36 V. In the present embodiment, the first battery pack 33E and the second battery pack 34E each have a rated voltage of 18 V, and a maximum rated voltage of 20 V.

The first battery pack 33E and the second battery pack 34E have the same outer shape and dimensions.

In other words, the first battery pack 33E and the second battery pack 34E are of the same type.

The first battery mount 31E and the second battery mount 32E include terminals with the same structure and dimensions.

In the present embodiment, the anvil 16E has a maximum tightening torque value less than 3000 Nm. The anvil 16E may have a maximum tightening torque value of 2000 to 4000 Nm inclusive.

The impact wrench 1E according to the present embodiment has the specifications below.
The total rated voltage of the battery packs: about greater than or equal to 36 V
The outer diameter of the stator core: greater than or equal to 80 mm (140 mm at maximum)
The maximum tightening torque value of the anvil: about 3000 Nm (or may also be 2000 to 3000 Nm inclusive, or 3000 to 4000 Nm inclusive)
The striking speed of the striker: 900 rpm (or may also be 700 to 1500 rpm inclusive)
The unloaded rotational speed of the anvil: 685 rpm (or may also be 500 to 1000 rpm inclusive)
The deceleration ratio of the reducer: 1/33.7 (or may be within the range of 1/25 to 1/40)
The weight of the hammer: 1.3 kg (or may also be 1 to 1.5 kg inclusive)
The length of a side of the socket mount in the anvil: 1 inch (or may also be 0.5 to 1.5 inches inclusive)
The outer dimensions of the impact wrench without the battery pack attached: 197 mm in Z-direction, 130 mm in Y-direction, and 456 mm in X-direction (or may be 180 to 210 mm inclusive in Z-direction, 110 to 140 mm inclusive in Y-direction, and 400 to 500 mm inclusive in X-direction)
The weight of the impact wrench without the battery pack attached: 10 kg (or may also be 7 to 13 kg inclusive)

As described above, the impact wrench 1E according to the present embodiment includes the motor 10E as a brushless motor, the striker 15E rotatable by the motor 10E, the anvil 16E strikable by the striker 15E to rotate about the output rotation axis AX extending in the direction parallel to X-axis, the first battery mount 31E to which the first battery pack 33E is attachable, and the second battery mount 32E to which the second battery pack 34E is attachable and being not aligned with the first battery mount 31E in the direction parallel to X-axis.

This reduces the likelihood that the work efficiency is decreased.

The first battery pack 33E in the embodiment is slid relative to the first battery mount 31E in the direction parallel to X-axis, or from the end in the positive X-direction toward the end in the negative X-direction, to be attached to the first battery mount 31E. The second battery pack 34E is slid relative to the second battery mount 32E in the direction parallel to X-axis, or from the end in the negative X-direction toward the end in the positive X-direction, to be attached to the second battery mount 32E.

This reduces the likelihood that the work efficiency is decreased.

The impact wrench 1E according to the embodiment includes the body housing 2E accommodating the motor 10E. In the direction parallel to Y-axis being orthogonal to X-axis, the body housing 2E has its end in the negative Y-direction located farther in the negative Y-direction than the end of the first battery pack 33E in the negative Y-direction and the end of the second battery pack 34E in the negative Y-direction. The body housing 2E has its end in the positive Y-direction located farther in the positive Y-direction than the end of the first battery pack 33E in the positive Y-direction and the end of the second battery pack 34E in the positive Y-direction.

This reduces the likelihood that the work efficiency is decreased.

The impact wrench 1E according to the embodiment includes the motor 10E as a brushless motor, the striker 15E rotatable by the motor 10E, the anvil 16E strikable by the striker 15E to rotate about the output rotation axis AX extending in the direction parallel to X-axis, the first battery mount 31E to which the first battery pack 33E is attachable, and the second battery mount 32E to which the second battery pack 34E is attachable and being adjacent to the first battery mount 31E.

This reduces the likelihood that the work efficiency is decreased.

### Sixth Embodiment

A sixth embodiment will be described. The same reference numerals hereafter denote the same or corresponding components as in the above embodiments, and such components will be described briefly or will not be described.

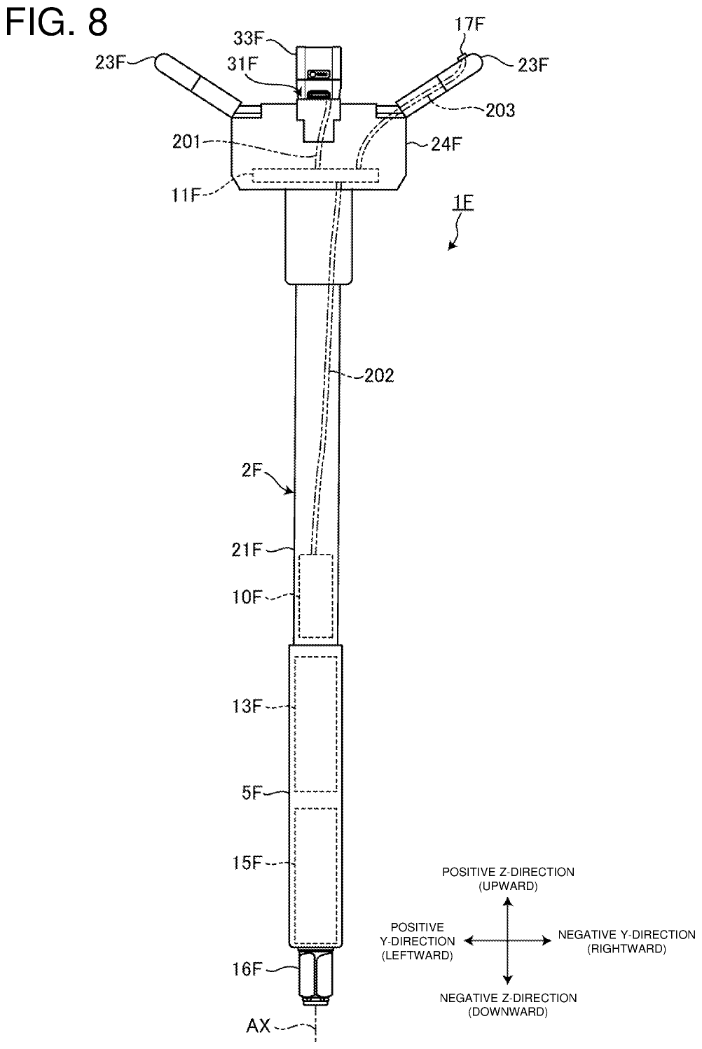

FIG. 8 is a diagram of an impact wrench 1F according to the sixth embodiment.

The impact wrench 1F includes a body housing 2F, a gear case 5F, a controller 11F, a motor 10F, a reducer 13F, a striker 15F, an anvil 16F, a trigger switch 17F, and a battery mount 31F. The body housing 2F and the gear case 5F are elongated in the vertical direction.

The body housing 2F includes a body 21F, a controller compartment 24F, and grips 23F. The body 21F accommodates the motor 10F. The controller compartment 24F is located in an upper portion of the body 21F. The grips 23F are located in an upper portion of the controller compartment 24F. The trigger switch 17E is located on the grip 23F. A vertical dimension from the upper ends of the grips 23F to the lower end of the anvil 16F is about 1000 to 1800 mm inclusive. When the vertical dimension from the upper end of the grip 23F to the lower end of the anvil 16F is 1200 to 1600 mm inclusive, the impact wrench 1F is easier to operate.

The motor 10F includes a rotor rotatable about the motor rotation axis extending in the vertical direction. The output rotation axis AX also extends in the vertical direction. The motor rotation axis aligns with the output rotation axis AX. The reducer 13F includes its output shaft that aligns with the motor rotation axis and the output rotation axis AX.

The controller 11F is located upward from the motor 10F. The controller 11F is accommodated in the controller compartment 24F.

The grips 23F are located in an upper left portion and in an upper right portion of the controller compartment 24F. The trigger switch 17F is located on the grip 23F on the right.

The battery mount 31F and the controller 11F are connected with a battery power supply line 201. The controller 11F and the motor 10F are connected with a motor power supply line 202. The trigger switch 17F and the controller 11F are connected with a trigger signal line 203.

The reducer 13F and the striker 15F are accommodated in the gear case 5F. The gear case 5F is located downward from the body housing 2F. The striker 15F may be accommodated in a separate hammer case. In this case, the hammer case is located below the gear case 5F.

The reducer 13F is located downward from the motor 10F. The striker 15F is located downward from the reducer 13F. The anvil 16F is strikable by the striker 15F in the rotation direction. The anvil 16F has its lower end protruding downward from the lower end of the gear case 5F. The anvil 16F rotates about the output rotation axis AX extending in Z-direction. The anvil 16F has a prismatic shape.

A battery pack 33F is detachably attached to the battery mount 31F. The battery mount 31F is located in the upper portion of the controller compartment 24F in the body housing 2F.

The battery pack 33F is slid forward (in the positive X-direction) relative to the battery mount 31F from the rear (located in the negative X-direction) to be attached to the battery mount 31F.

The battery pack 33F may have a rated voltage of 18 or 36 V. The battery pack 33F in the present embodiment has a rated voltage of 36 V and a maximum rated voltage of 40 V.

In the present embodiment, the anvil 16F has a maximum tightening torque value less than 3000 Nm.

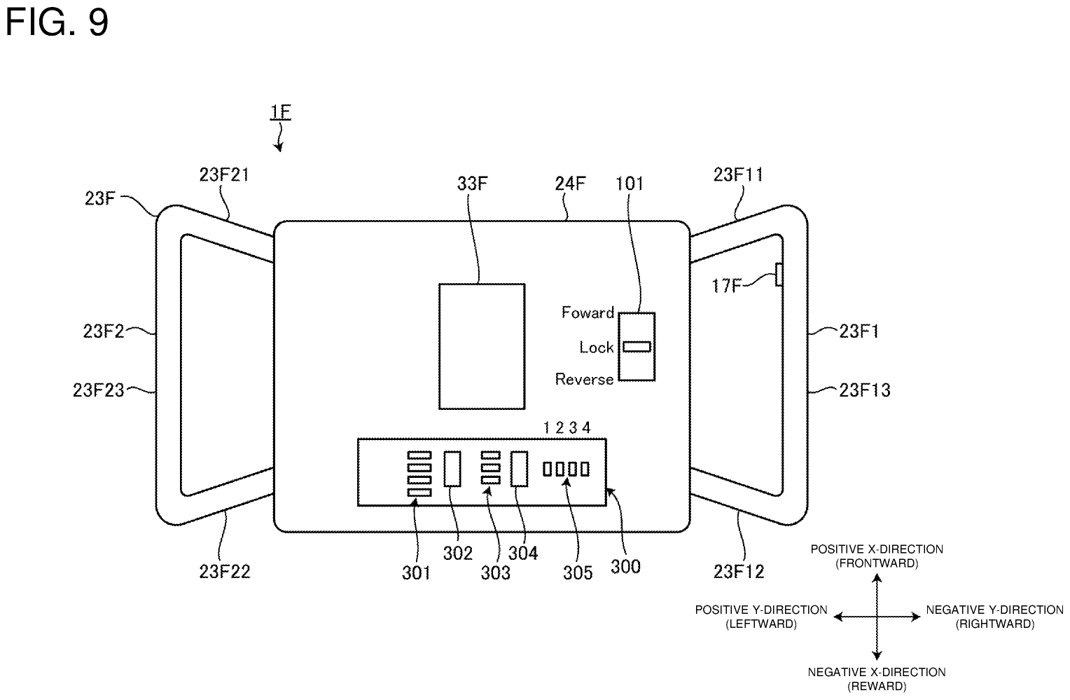

FIG. 9 is a plan view of the impact wrench 1F according to the sixth embodiment. The grips 23F include a right grip 23F1 and a left grip 23F2. In the impact wrench 1F, the right grip 23F1 is located rightward from the controller compartment 24F. The left grip 23F2 is located leftward from the controller compartment 24F.

The right grip 23F1 defines a loop with the controller compartment 24F. The right grip 23F1 includes a portion 23F11, a portion 23F12, and a portion 23F13. The portion 23F11 extends rightward (laterally) from the front of the controller compartment 24F. The portion 23F12 extends rightward (laterally) from the rear of the controller compartment 24F. The portion 23F13 connects the portion 23F11 and the portion 23F12.

The left grip 23F2 defines a loop with the controller compartment 24F. The left grip 23F2 includes a portion 23F21, a portion 23F22, and a portion 23F23. The portion 23F21 extends leftward (laterally) from the front of the controller compartment 24F. The portion 23F22 extends leftward (laterally) from the rear of the controller compartment 24F. The portion 23F23 connects the portion 23F21 and the portion 23F22.

The trigger switch 17F is located in a front portion of the portion 23F13. In response to an operation on the trigger switch 17F, the motor 10F receives a current. This operation on the trigger switch 17F causes the motor 10F to rotate.

The controller compartment 24F includes a forward-lock-reverse switch 101 rightward from the battery pack 33F. The forward-lock-reverse switch 101 is operable in the front-rear direction. With the forward-lock-reverse switch 101 at a front position, the motor 10F can rotate in the forward direction. With the forward-lock-reverse switch 101 at a rear position, the motor 10F can rotate in the reverse direction. With the forward-lock-reverse switch 101 at a middle position in the front-rear direction, the motor 10F cannot rotate.

A panel 300 is located rearward from the battery pack 33F on the controller compartment 24F. The panel 300 is at least partially displayable and operable. The display is performed using one or more light-emitting diodes (LEDs, possibly with different colors).

The panel 300 includes buttons for operation.

The panel 300 is elongated in the lateral direction. The panel 300 is a component separate from the controller compartment 24F and is formed from a resin. The panel 300 includes a battery remaining level indicator LED 301, a mode selection button 302, a mode indicator LED 303, a speed change button 304, and a speed indicator LED 305 in this order from the left to the right.

The battery remaining level indicator LED 301 includes four LED chips aligned in the front-rear direction. When the rearmost LED emits light, the battery pack 33F has a remaining power level of 25%. When the two rear LEDs emit light, the battery pack 33F has a remaining power level of 50%. When the three LEDs emit light, the battery pack 33F has a remaining power level of 75%. When all the four LEDs emit light, the battery pack 33F has a remaining power level of 100%. With the battery pack 33F attached to the battery mount 31F, the battery remaining level indicator LED 301 emits light in response to an operation on the trigger switch 17F.

The mode selection button 302 is a press-on switch. The mode selection button 302 is pressed to input a signal into the controller 11F. The motor 10F then rotates in a selected rotational mode.

In the present embodiment, three rotational modes are available. The first rotational mode is an auto-stop mode. In the auto-stop mode, the motor 10F automatically stops rotating under a predetermined condition. The predetermined condition may be set as appropriate. Examples of the predetermined condition include the time when the tightening torque reaches a predetermined torque value, the time when five seconds have passed after the motor 10F received a specified value of current, and the time when 30 seconds have passed after the motor 10F started rotating.

The second rotational mode is a multi-speed mode. In the multi-speed mode, the motor 10F has a rotational speed of, for example, 10000 rpm, 20000 rpm, 30000 rpm, or 40000 rpm.

The third rotational mode is a boost mode. For example, the motor 10F rotating in the reverse direction is expected to use more torque. A nut stuck with, for example, rust is to be loosened. The mode selection button 302 is pressed to rotate the motor at a rotational speed that is 120% of an initial rotational speed. For the initial rotational speed of the motor being 1000 rpm, the revolutions per minute is increased to, for example, 12000 rpm.

The mode indicator LED 303 displays a mode selected with the mode selection button 302. When the front LED is lit alone, the automatic stop mode is selected. When the middle LED is lit alone, the multi-speed mode is selected. When the rear LED is lit alone, the boost mode is selected.

The speed change button 304 is a press-on switch for changing the rotational speed of the motor. The speed change button 304 can be used to switch the rotational speed of the motor 60 to 10000 rpm, 20000 rpm, 30000 rpm, or 40000 rpm. The speed change button 304 can be used to switch the rotational speed sequentially to 10000 rpm when pressed once, to 20000 rpm when pressed twice, to 30000 rpm when pressed three times, to 40000 rpm when pressed four times, or to 10000 rpm again when pressed five times.

When the leftmost LED is lit alone, the speed indicator LED 305 indicates 10000 rpm. When the left two LEDs are lit, the LED speed indicator 305 indicates 20000 rpm. When the three LEDs are lit, the LED speed indicator 305 indicates 30000 rpm. When the four LEDs are lit, the LED speed indicator 305 indicates 40000 rpm.

An impact tool according to the embodiment includes
a head to hold a battery pack,
a grip being a loop and located on a left and a right of the head,
a rod extending downward from the head,
a motor located in a front portion of the rod,
a reducer below the motor,
a striker below the reducer, and
an anvil strikable by the striker in a rotation direction.

The impact wrench 1F according to the present embodiment has the specifications below.
The total rated voltage of the battery pack: greater than or equal to 18 V (or may be 18 to 36 V inclusive)
The outer diameter of the stator core: greater than or equal to 50 mm
The maximum tightening torque value of the anvil: about 1700 Nm (or may be 800 to 2000 Nm inclusive)
The striking speed of the striker: 2500 rpm (or may be 2000 to 3000 rpm inclusive)
The unloaded rotational speed of the anvil: 1800 rpm (or may be 1200 to 2400 rpm inclusive)
The deceleration ratio of the reducer: 1/15.7 (or may be within the range of 1/12 to 1/20)
The weight of the hammer: 0.4 kg (or may also be 0.2 to 0.6 kg inclusive)
The length on a side of the socket mount in the anvil: 1 inch (or may be 0.25 to 1 inch inclusive)
The outer dimensions of the impact wrench without the battery pack attached: 322 mm in X-direction, 408 mm in Y-direction, and 1300 mm in Z-direction (or may be 1000 to 1800 mm inclusive in Z-direction)
The weight of the impact wrench without the battery pack attached: 5 kg

### Seventh Embodiment

A seventh embodiment will be described. The same reference numerals hereafter denote the same or corresponding components as in the above embodiments, and such components will be described briefly or will not be described.

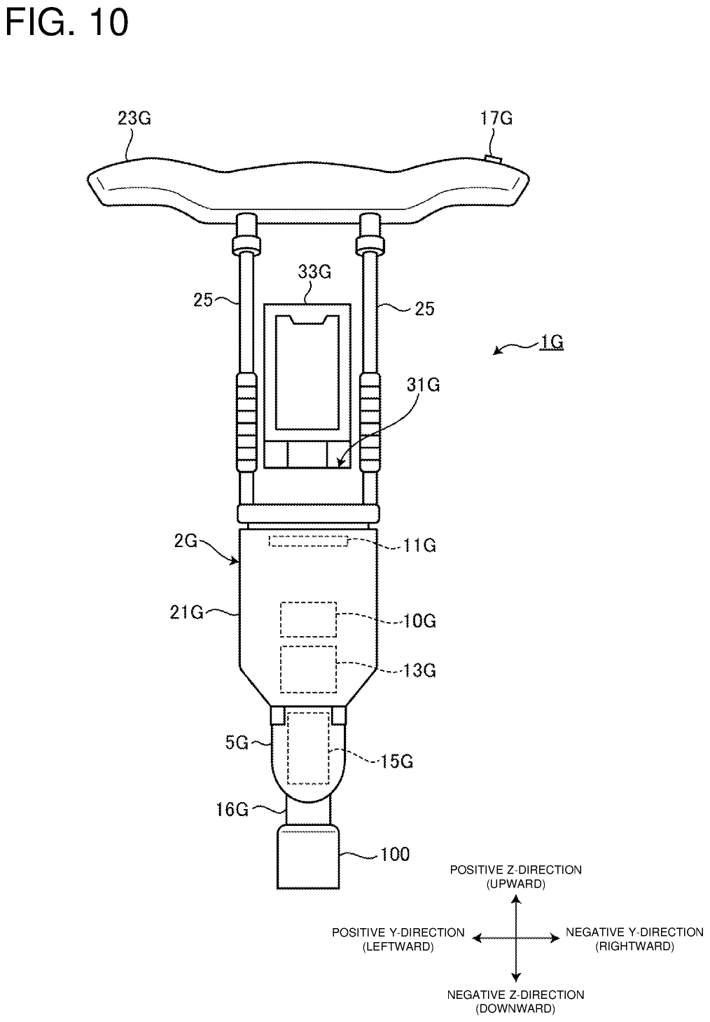

FIG. 10 is a diagram of an impact wrench 1G according to the seventh embodiment.

The impact wrench 1G includes a body housing 2G, a gear case 5G, a controller 11G, a motor 10G, a reducer 13G, a striker 15G, an anvil 16G, a trigger switch 17G, and a battery mount 31G.

The body housing 2G includes a body 21G, two arms 25, and a grip 23G. The body 21G accommodates the motor 10G. The two arms 25 are located above the body 21G. The grip 23G is located above the arms 25. The trigger switch 17G is located on the grip 23G.

The motor 10G includes a rotor rotatable about the motor rotation axis extending in the vertical direction. The output rotation axis AX also extends in the vertical direction. The motor rotation axis aligns with the output rotation axis AX.

The controller 11G is located upward from the motor 10G. The controller 11G is accommodated in the body 21G.

The reducer 13G is accommodated in the body 21G. The striker 15G is accommodated in the gear case 5G. The gear case 5G is located downward from the body housing 2G.

The reducer 13G is located downward from the motor 10G. The striker 15G is located downward from the reducer 13G. The anvil 16G is strikable by the striker 15G in the rotation direction. The anvil 16G has its lower end protruding downward from the lower end of the gear case 5G. A socket 100 is attached to the lower end of the anvil 16G. The anvil 16G rotates about the output rotation axis AX extending in Z-direction.

A battery pack 33G is detachably attached to the battery mount 31G. The battery mount 31G is located in an upper portion of the body housing 2G.

The battery pack 33G is slid forward (in the positive X-direction) relative to the battery mount 31G from the rear (located in the negative X-direction) to be attached to the battery mount 31G.

The battery pack 33G may have a rated voltage of 18, 36, or 72 V. The battery pack 33G in the present embodiment has a rated voltage of 72 V, and a maximum rated voltage of 80 V.

In the present embodiment, the anvil 16G has a maximum tightening torque value less than 3000 Nm.

The impact wrench 1G according to the present embodiment has the specifications below.
The total rated voltage of the battery pack: about greater than or equal to 75 V
The outer diameter of the stator core: greater than or equal to 80 mm
The maximum tightening torque value of the anvil: about 7500 Nm
The striking speed of the striker: 1000 rpm
The unloaded rotational speed of the anvil: 761 rpm
The deceleration ratio of the reducer: 1/39.4
The weight of the hammer: 4.5 kg
The length on a side of the socket mount in the anvil: 1.5 inch
The outer dimensions of the impact wrench without the battery pack attached: 540 mm in X-direction, 219 mm in Y-direction, and 854 mm in Z-direction
The weight of the impact wrench without the battery pack attached: 30 kg

The impact wrench 1G according to the present embodiment may have the specifications below.
The total rated voltage of the battery pack: about greater than or equal to 75 V
The outer diameter of the stator core: greater than or equal to 80 mm
The maximum tightening torque value of the anvil: about 7500 Nm
The striking speed of the striker: 1500 rpm
The unloaded rotational speed of the anvil: 1150 rpm
The deceleration ratio of the reducer: 1/26.3
The weight of the hammer: 2.0 kg
The length on a side of the socket mount in the anvil: 1.5 inch
The outer dimensions of the impact wrench without the battery pack attached: 540 mm in X-direction, 219 mm in Y-direction, and 854 mm in Z-direction
The weight of the impact wrench without the battery pack attached: 30 kg

### REFERENCE SIGNS LIST

1A impact wrench
1B impact wrench
1C impact wrench
1D impact wrench
1E impact wrench
1F impact wrench
1G impact wrench
2A body housing
2B body housing
2C body housing
2D body housing
2E body housing
2F body housing
2G body housing
2L left body housing
2R right body housing
3 first battery connector housing
3C battery connector housing
4 motor case
5 gear case
5D gear case
5E gear case
5F gear case
5G gear case
6 hammer case
7 side handle
7A handle portion
7B base
7D handle
7E handle
8 bumper
9 hanging ring
10A motor
10D motor
10E motor
10F motor
10G motor
11A controller
11D controller
11E controller
11F controller
11G controller
12 fan
13A reducer
13D reducer
13E reducer
13F reducer
13G reducer
14 spindle
14A flange
14B spindle shaft
14C protrusion
15A striker
15D striker
15E striker
15F striker
15G striker
16A anvil
16B anvil
16C anvil
16D anvil
16E anvil
16F anvil
16G anvil
17A trigger switch
17B trigger switch
17C trigger switch
17D trigger switch
17E trigger switch
17F trigger switch
17G trigger switch
18 light assembly
21 body
21D body
21E body
21F body
21G body
22A second battery connector housing
22B battery connector housing
22C protrusion
23 grip
23A rear grip
23B upper grip
23D grip
23E grip
23F grip
23F1 right grip
23F11 portion
23F12 portion
23F13 portion
23F2 left grip
23F21 portion
23F22 portion
23F23 portion
23G grip
24 controller compartment
24F controller compartment
25 arm
26 inlet
27 outlet
31A first battery mount
31B first battery mount
31C first battery mount
31D first battery mount
31E first battery mount
31F battery mount
31G battery mount
32A second battery mount
32B second battery mount
32C second battery mount
32D second battery mount
32E second battery mount
33A first battery pack
33B first battery pack
33C first battery pack
33D first battery pack
33E first battery pack
33F battery pack
33G battery pack
34A second battery pack
34B second battery pack
34C second battery pack
34D second battery pack
34E second battery pack
40 bearing cover
40S screw
41 screw
45 spring
46 rubber buffer
47 stator
48 rotor
49 rotor shaft
50 sensor board
51 rotor bearing
52 rotor bearing
53 first bevel gear
54 second bevel gear
55 planetary gear assembly
55A pin
55I internal gear
55P planetary gear
55S sun gear
56 gear bearing
57 gear bearing
58 spindle bearing
61 first cylinder
62 second cylinder
63 front wall
71 hammer
71A hammer body
71B hammer projection
71C recess
72 ball
73 first coil spring
74 second coil spring
75 third coil spring
76 first washer
77 second washer
78 ball
79 anvil bearing
100 socket
101 forward-lock-reverse switch
161 anvil shaft
162 anvil projection
201 battery power supply line
202 motor power supply line
203 trigger signal line
300 panel
301 battery remaining level indicator LED
302 mode selection button
303 mode indicator LED
304 speed change button
305 speed indicator LED
MX motor rotation axis
AX output rotation axis

What is claimed is:

1. An impact wrench, comprising:
an anvil to which a socket is attachable;
a hammer at least partially located above the anvil, the hammer being configured to strike the anvil in a rotation direction;
a brushless motor located above the hammer, the brushless motor including
a rotor configured to rotate the hammer, and
a stator facing the rotor;
a controller configured to control rotation of the brushless motor;
a case accommodating the hammer;
a rod located above the case;
a head located above the rod and accommodating the controller, the head including
a battery mount to which a battery pack is attachable in a slidable manner,
a forward-reverse switch configured to change a rotation direction of the brushless motor, and
a panel located in an upper portion of the head and elongated in a lateral direction, the panel including
a speed change button configured to change a rotational speed of the brushless motor, and
a speed indicator light-emitting diode including a plurality of light-emitting diodes each to be lit based on the rotational speed of the brushless motor selected with the speed change button; and
a grip extending from the head in the lateral direction, the grip including a trigger switch configured to rotate the brushless motor.

2. The impact wrench according to claim 1, wherein
the battery pack has a rated voltage of 18 V.

3. The impact wrench according to claim 1, wherein
the stator includes a stator core having an outer diameter greater than or equal to 50 mm.

4. The impact wrench according to claim 1, further comprising:
a reducer between the brushless motor and the hammer,
wherein the reducer has a reduction ratio of 1/12 to 1/20.

5. The impact wrench according to claim 1, wherein
the anvil has a maximum tightening torque value of 800 to 2000 Nm inclusive.

6. The impact wrench according to claim 1, wherein
the impact wrench without the battery pack attached has a vertical outer dimension of 1000 to 1800 mm inclusive.

7. The impact wrench according to claim 1, wherein
the anvil is prismatic.

8. The impact wrench according to claim 7, wherein
the anvil includes a socket mount to which the socket is attachable, and
the socket mount has a length of one inch on a side of the socket mount.

9. The impact wrench according to claim 2, wherein
the stator includes a stator core having an outer diameter greater than or equal to 50 mm.

10. The impact wrench according to claim 2, further comprising:
a reducer between the brushless motor and the hammer,
wherein the reducer has a reduction ratio of 1/12 to 1/20.

11. The impact wrench according to claim 3, further comprising:
a reducer between the brushless motor and the hammer,
wherein the reducer has a reduction ratio of 1/12 to 1/20.

12. The impact wrench according to claim 2, wherein
the anvil has a maximum tightening torque value of 800 to 2000 Nm inclusive.

13. The impact wrench according to claim 3, wherein
the anvil has a maximum tightening torque value of 800 to 2000 Nm inclusive.

14. The impact wrench according to claim 4, wherein
the anvil has a maximum tightening torque value of 800 to 2000 Nm inclusive.

15. The impact wrench according to claim 2, wherein
the impact wrench without the battery pack attached has a vertical outer dimension of 1000 to 1800 mm inclusive.

16. The impact wrench according to claim 3, wherein
the impact wrench without the battery pack attached has a vertical outer dimension of 1000 to 1800 mm inclusive.

17. The impact wrench according to claim 4, wherein
the impact wrench without the battery pack attached has a vertical outer dimension of 1000 to 1800 mm inclusive.

18. The impact wrench according to claim 5, wherein
the impact wrench without the battery pack attached has a vertical outer dimension of 1000 to 1800 mm inclusive.

19. The impact wrench according to claim 2, wherein
the anvil is prismatic.

20. The impact wrench according to claim 3, wherein
the anvil is prismatic.
